(19) United States
(12) Patent Application Publication
(10) Pub. No.: US 2008/0010028 A1
(43) Pub. Date: Jan. 10, 2008

(54) Process for Determining Local Emissivity Profile of Suprathermal Electrons

(75) Inventors: Didier Mazon, Osloo Manosque (FR); Oliveiro Barana, Aix-En-Provence (FR); Yves Peysson, Aix en Provence (FR)

Correspondence Address: THELEN REID BROWN RAYSMAN & STEINER LLP, P. O. BOX 640640, SAN JOSE, CA, 95164-0640, US

(73) Assignee: Commissariat Al'energie Atomique, Paris (FR)

(21) Appl. No.: 11/793,870

(22) PCT Filed: Dec. 15, 2005
(86) PCT No.: PCT/EP05/56829

§ 371 Date: Jun. 21, 2007

(30) Foreign Application Priority Data
Dec. 22, 2004 (EP) 04 300 933.1

(51) Int. Cl. G06F 19/00

(52) U.S. Cl. 702/30

(57) ABSTRACT

The invention concerns a process for determining a local emissivity profile of suprathermal electrons coming from an ionized gas ring placed in a toric vessel, with the use of tomographic inversion by means of Bessel functions Jo of order 0 which exploits line-integrated measurements acquired by current real-time Hard-X-Ray diagnostics.

### TECHNICAL FIELD AND PRIOR ART

The invention concerns a process for determining local emissivity profile of Suprathermal Electrons (SE) starting from measurement data acquired by Hard X-Ray (HXR) diagnostics.

More particularly, the invention deals with a real-time process for determining local emissivity profile of suprathermal electrons specially adapted to temporal constraints and performing the inversion of line integrated HXR measurements using Abel inversion techniques and geometrical data. The “real-time” notion concerns data acquisition and associated treatments on a time scale shorter or equivalent to the main characteristic time of the considered physic process which is, within the framework of the invention, correlated to the diffusion time of the HXR local emissivity profile (some tenths of ms).

The main application of the process according to the invention is the real-time control of the profile, which has direct and important effects on the global confinement and on the performances in magnetically confined fusion plasmas.

Controlled nuclear fusion seems to be nowadays the most tempting candidate for the production of clean and basically unlimited energy, in substitution to the fossil one, which is polluting and limited to few decades yet.

Its principle is simple, the objective being to reproduce on earth, inside a machine called Tokamak, the same mechanisms taking place in the sun. An ionized gas ring at very high temperature called plasma, strongly confined by the combined action of a high magnetic field and an intense electrical current of some mega-amps, develops in its centre deuterium-tritium fusion reactions producing neutrons, which convey energy: this is the basis of the Tokamak principle.

The optimization of the physical and technological constraints of a fusion device leads to the definition of the concept of ‘advanced Tokamak’. It consists in producing stationary improved confinement modes in which the total amount of current is generated in a non-inductive way (an important part of it is given by the auto-generated plasma bootstrap current). The achievement of such ‘advanced Tokamak’ modes requires the capability to control the current density profile, which can be obtained only by means of additional methods of generation of non-inductive current. Among the various methods known about Tokamaks, the injection of high power electromagnetic waves constitutes an ideal candidate for the generation of additional non-inductive current in the plasma. For this reason it is crucial to be able to control the power deposition profile of the hybrid wave, which is currently the most effective method for generating additional current. The propagation and the absorption of this wave are studied in the Tokamak Tore Supra (TS) by means of a spectrometric HXR diagnostics. The measurement of the radiation emitted in the range of HXR by the SE accelerated by the hybrid wave is the most effective method to get information about the wave power deposition profile. This fact justified the installation in TS, in January 1996, of a new HXR diagnostics of spectrometry having excellent space and temporal resolution, particularly adapted to study the control of the current profile over long periods (see reference [1]). The spectrometric system comprises 59 detectors distributed into 2 cameras, one horizontal and the other vertical, thus making it possible to increase the space redundancy of measurements, by intercepting the plasma section with detectors' lines of sight whose slopes are very different. The diagnostics measures the plasma emissivity integrated along each line of sight, the main objective being to determine the radial profile of the plasma emissivity from raw integrated measurements. This can be carried out by a traditional Abel inversion method under certain assumptions.

FIG. 1 represents a cross view of a Tore Supra vacuum vessel V together with an example of circular plasma CP and lines of sight L (chords) of HXR diagnostics. The configuration shown in FIG. 1 consists of two cameras 1a, 1b and a vessel V in which is located the circular plasma CP. Camera 1a is a vertical camera with 21 lines of sight L and camera 1b is a horizontal camera with 38 lines of sight L. This configuration is not the unique possible one. For example, the cameras could invert their position, or could change their relative position in the framework of the cut plane, or as well only one camera can be used. The photons emitted by the plasma release all or a part of their energy when they hit the detectors placed in the cameras. The energy released at that time is converted into a pulse. The detectors are made of Cadmium-Tellurium (CdTe) semiconductors. The treatment of the pulses coming from the detectors is carried out by a processing electronic chain especially optimized for CdTe. FIG. 2 represents such a processing electronic chain according to the prior art.

The processing electronic chain comprises a camera 1, a receiver frame 2, a polarization circuit 3, a power supply circuit 4, a calibration circuit 5, a processing circuit 6 and a data storage unit 7. A switch 8 connects the output from the receiver frame 2 either to the input of the processing circuit 6 (in the measurement phase) or to the input of the calibration circuit 5 (in the calibration phase). The camera 1 comprises a detector 9 based on a CdTe semiconductor, a preamplifier 10 and a differential emitter 11. The receiver frame 2 comprises a differential receiver 12 and a linear amplifier 13. The polarisation circuit 3 polarises the detector, for example with a polarisation voltage equal to −100 V. The power supply circuit 4 supplies power to the electrical circuits 10 and 11 of the camera 1 and 12 and 13 of the receiver frame 2, for example with a +/−12V, 40 mA power supply. The processing circuit 6 comprises a set of discriminators D1 to D8, a set of counters C1 to C8 and a data acquisition unit 14.

The detector 9 is a material medium in which the photons P emitted by the plasma transfer all or some of their energy. The energy transferred in the detector is converted into electrical pulses, that are then processed by an electronic counting system specially optimized for CdTe. Charge carriers in the semiconductor are collected by the preamplifier 10. The differential emitter 11 transmits the signal output by the preamplifier 10, through the differential receiver 12, to the linear amplifier 13, more commonly called the “shaper”. The function of the shaper is to transform received pulses, usually having a fairly long relaxation time and consequently having the risk of overlapping if the count rate becomes too high, into fairly short pulses that can be easily counted in the last part of the acquisition system. The gain of the shaper may be adjusted manually in order to calibrate the signal inside the energy domain.

During the measurement phase, the switch 8 connects the output from the receiver frame 2 to the input of the processing circuit 6. The received pulse height is then analyzed by the eight integral discriminators D1-D8. The integral discriminators D1-D8 send logical signals to the counters C1-C8 to which they are connected, when the amplitude of the rising front of the pulse is greater than a discrimination threshold. Reception of the logical signal by a counter Ci (i=1, 2, . . . , 8) adds 1 to the buffer memory of the counter Ci, that consequently contains the number of counts recorded with energy greater than the discrimination threshold. At each sampling step (i.e. the time at which data are acquired, for example 16 ms), the buffer memory of each counter is read and is then reset to zero by the data acquisition unit 14 that transmits the eight count results in the data storage unit 7.

This system has several disadvantages.

Firstly, no information related to the input signal is available, which prevents any display of the shaped pulse so that stacking as a result of the simultaneous arrival of two photons on the detector cannot be distinguished. Also, the measured signals are not available in real time, which prevents any profile inversion in real time and consequently any feedback control of the power deposit of the hybrid wave and any feedback control of the current profile.

A calibration step is necessary to obtain reliable measurements. The output from the receiver frame 2 is then connected to the input of the calibration frame 5.

Calibration consists of adjusting the gain of the shaper circuit so as to have good correspondence between the amplitude of the pulse output by the receiver frame 2 and the energy of the incident photon. As it has already been mentioned above, the spectrometric system according to prior art comprises two cameras, one vertical and the other horizontal, including 21 detectors for the vertical camera and 38 detectors for the horizontal camera, giving a total of 59 detectors. The calibration is then done for each detector.

Calibration is essential in order to obtain a precise reconstruction of emissivity profiles in the different energy channels. Calibration may then be done using a digital spectrometer with 1024 channels and using three radioactive sources. The gain of the shaper is then adjusted so as to put the main peak of each source at the right energy.

The calibration step also has disadvantages. It requires disconnection of part of the electronics of the acquisition system that is then not included in the calibration. The result might lead to calibration errors. Furthermore, this disconnection increases manipulations made on the system and consequently risks of deterioration of the system. Furthermore, the camera 1 is far from the acquisition system to which the calibration bench is connected. This then means that the operator needs to go back and forward many times when he has to modify the position of the source with respect to the camera.

The above mentioned disadvantages are cancelled by means of an acquisition electronic circuit which is the subject of a French patent application entitled “Circuit électronique de diagnostic de spectrométrie” filed at the French Patent Office in the name of the Applicant with the filing number 04 50338, on Feb. 24, 2004. This acquisition electronic circuit is described below from FIG. 3 to FIG. 7.

The process according to the invention processes the data output from an acquisition electronic circuit as the one described in the above mentioned French patent application. An advantage of the process according to the invention is to obtain a real-time emissivity profile (treatment which is performed, for example, within the aforementioned 16 ms) and, therefore to possibly allow a real-time emissivity profile monitoring and control.

The process according to the invention contains some computation steps. It is to be noted that symbol “*” is used to represent any kind of multiplication in these computations.

### STATEMENT OF THE INVENTION

The invention concerns a process for determining a local emissivity profile of suprathermal electrons coming from an ionized gas ring, called plasma, placed in a toric vessel, with the use of a spectrometric system comprising at least one detector, the detector being positioned in relation with the toric vessel so that the line of sight of the detector intercepts a cross section of the toric vessel and a cross section of the ionized gas ring with radius “a”, said cross section of the ionized gas ring being off centre against said cross section of the toric vessel, characterized by the following steps:
to compute the first NB zeros Z₁, Z₂, . . . , Z_{NB} of the Bessel function Jo of order 0,
to build a matrix J_{ρ}, the element of row k and column j of which is Jo(ρₖ*Zⱼ), with Jo(ρₖ*Zⱼ) being the function Jo of order 0 of arguments (ρₖ*Zⱼ) (k=1, 2, . . . , N_{M} and j=1, 2, . . . , NB), with ρₖ the normalized distance with respect to radius “a” between a point Pₖ of the plasma and the plasma centre, the matrix J_{ρ} being such that:
   A_{ρ}=J_{ρ}*C,
   with A_{ρ} being an array, the elements of which represent the emissivity profile along a normalized plasma radius ρ and C being a matrix of coefficients,
to read measurement data, said measurement data comprising a plasma emissivity datum Y representing the plasma integrated emissivity measured by the detector along the line of sight, plasma centre coordinates comprising major radius value Rp and vertical shift value Zp, and plasma minor radius “a”,
to compute the geometrical position of the line of sight segment which intercepts the cross section of the ionized gas ring with respect to a coordinate system centred in (Rp, 0, Zp),
to compute the position of NL successive points P₁, P₂, . . . , P_{NL} on said line of sight segment, P₁ and P_{NL} being the points of said line of sight segment which intercept boundaries of the ionized gas ring cross section,
to compute the distances rᵢ between the points Pᵢ (i=1, 2, . . . , NL) and the plasma centre and to computate the normalized distances ρᵢ=rᵢ/a,
to build a matrix J_{ρi}, the element of row i and column j of which is Jo(ρᵢ*Zⱼ), with Jo(ρᵢ*Zⱼ) being the function Jo of order 0 of arguments ρᵢ*Zⱼ (i=1, 2, . . . , NL and j=1, 2, . . . , NB), the matrix J_{ρi} being such that:
   A_{ρi}=J_{ρi}*C,
   with A_{ρi} being an array representing the emissivity profile along the normalized distances ρᵢ and C being said matrix of coefficients,
to compute for each column j of J_{ρi} (j=1, 2, . . . , NB) the integral Fⱼ such that:
   Fⱼ=δ*ΣᵢJo(ρᵢ*Zⱼ)

where δ is a geometric constant and i goes from 1 to NL,
to compute a matrix F such that:
   F=[F₁F₂ . . . F_{NB}]
to compute a matrix F⁻¹, the pseudo-inverse matrix of matrix F,
to compute a matrix M such that:
   M=(J_{ρ}*F⁻¹)/EG
   with EG being the geometrical extension of the detector,
to calculate the suprathermal electron local emissivity profile array A_{ρ} such that:
   A_{ρ}=M*Y/1000

According to an additional feature, the process of the invention comprises a checking step to check the elements of the array A_{ρ}, said checking step comprising at least one of the following steps:
a) checking if the element of the array A_{ρ} which represents the local emissivity profile on the ionized gas ring circumference is different from zero,
b) checking if any element of the array A_{ρ} is a negative or a value superior to a threshold value,
c) checking if the number of local maxima of the array A_{ρ} is greater than a prefixed maximum number allowed,

According to another additional feature, the process of the invention comprises:
computation of (J_{ρ})⁻¹ the pseudo-inverse matrix of matrix J_{ρ},
computation of a matrix N such that:
   N=(F*(J_{ρ})⁻¹)*EG,
computation of the reconstructed line integrated measurement Y_{R} corresponding to the integrated plasma emissivity datum Y such that:
   Y_{R}=N*A_{ρ}*1000
computation of value χ² such that:

$${χ}^{2} = {\sum }_{n = 1}^{{NC}_{F}} {( {Y}_{n} - {Y}_{Rn} )}^{2} / {NC}_{F}$$

with Yₙ being the integrated plasma emissivity datum representing the integrated plasma emissivity measured by a detector of rank n, Y_{Rn} being the reconstructed line integrated measurement corresponding to the plasma emissivity datum Yₙ and NC_{F} being the number of detectors,
checking if χ² is greater than a fixed threshold.

According to another additional feature, before the computation of value χ², the process of the invention comprises a step for checking if at least one element of the array Y_{R} is negative.

According to another additional feature of the process of the invention, if at least one element of the array Y_{R} is negative, the process stops or it continues if not.

According to another additional feature of the process of the invention, if χ² is greater than a fixed threshold value, the process stops or it continues if not.

According to another additional feature of the process of the invention, if the points Pᵢ are equally spaced, the computation of the distances rᵢ between points Pᵢ (i=1, 2, . . . , NL) and the plasma centre is only made for the points Pᵢ located between P₁ and the middle of segment P₁P_{NL}, P₁ being included, or located between the middle of segment P₁P_{NL} and P_{NL}, P_{NL} being included.

According to another additional feature, the process of the invention comprises an averaging phase to calculate said measurement emissivity datum Y in the form of a mean of raw integrated emissivity data computed along a prefixed number of consecutive time samples.

According to another additional feature, the process of the invention comprises a step to filter raw measurement data.

According to another additional feature, the process of the invention comprises a preliminary step to compare a number of available lines of sight to a minimum value allowed, so that the process stops if said number of available lines of sight is lower than said minimum value allowed.

The invention also relates to a process for real-time determination of local emissivity profile of suprathermal electrons coming from an ionized gas ring, called plasma, placed in a toric vessel, said process comprising:
reading of at least one real-time measurement Y of integrated plasma emissivity along a line of sight of at least one detector positioned in relation with the toric vessel so that the line of sight of the detector intercepts a circular cross section of the toric vessel and a circular cross section of the ionized gas ring with radius “a”,
real-time reading of the plasma centre coordinates comprising major radius value Rp, vertical shift value Zp and plasma radius “a”,
real-time determination of the local emissivity profile based on a process according to the invention.

The process according to the invention allows the reconstruction, in Tore Supra (TS), of local emissivity profile of Suprathermal Electrons (SE) starting from integrated Hard-X-Ray (HXR) measurements data.

The process is based on a tomographic inversion and, more particularly, on an Abel inversion by means of Bessel functions Jo of order 0, which exploits the raw data (line-integrated measurements) acquired by the current real-time HXR TS diagnostics.

The reconstructed local emissivity profile can advantageously be controlled in feedback, with direct effects on the total current density profile. The algorithm also allows a check of the validity of the reconstructed profile based on its shape and on a comparison between the reconstructed raw data and the measured one (χ² comparison).

The algorithm can also exploit filtering techniques of raw data in order to avoid statistical noise. The reconstructed SE profile is normalized at the end and then sent (if all the validity conditions are satisfied) to the control system for the feedback control.

Advantageously, the process according to the invention has the following capabilities:
robustness;
reliability;
fast computational time in order to respect real-time constraints.

### BRIEF DESCRIPTION OF THE FIGURES

Other features and advantages of the invention will become clearer when reading a preferred embodiment of the invention described with reference to the appended figures, wherein:

FIG. 1 already described represents a cross section of a Tore Supra vacuum vessel together with an example of circular plasma;

FIG. 2 already described represents a HXR radiation diagnostic measurement chain according to the prior art;

FIG. 3 represents an example of a real-time acquisition electronic circuit intended to output the measurement data which are processed according to the process of the invention;

FIG. 4 is a typical representation of a signal which enters the real-time acquisition electronic circuit of FIG. 3;

FIG. 5 represents a detailed part of the real-time acquisition electronic circuit of FIG. 3;

FIG. 6 represents an example of contents of histogram memory;

FIG. 7 represents an improvement of the real-time acquisition electronic circuit of FIG. 3;

FIG. 8 represents an example of spectrometry diagnostic system with associated units which implement the process according to the invention;

FIG. 9A represents an above view of a Tore Supra vacuum vessel placed in a Cartesian coordinate system whose centre is the centre of the Tore Supra vacuum vessel;

FIG. 9B represents a cross view of the Tore Supra vacuum vessel of FIG. 9A;

FIG. 10 represents the values of NB Bessel functions Jo of order 0 (NB=6), computed along NM equally spaced points of a normalized plasma minor radius ρ multiplied by the first NB zeros Zᵢ (i=1 . . . NB) of the function Jo.

FIG. 11 represents, superimposed, the values of the NB Bessel functions Jo whose arguments are the distances rᵢ from the geometric center of the plasma (normalized with respect to the plasma minor radius a) of NL points of a portion of line of sight L included in the plasma, multiplied by the NB zeros Zᵢ.

FIG. 12 represents a simplified scheme of the overall process according to the invention;

FIG. 13 represents the basic steps of the process according to the invention;

FIGS. 14-26 represent flow-charts corresponding to the basic steps of FIG. 13.

FIG. 27 represents an example of SE local emissivity profile worked out with the adopted inversion method during a TS discharge (shot number 32570 at time t=10 s).

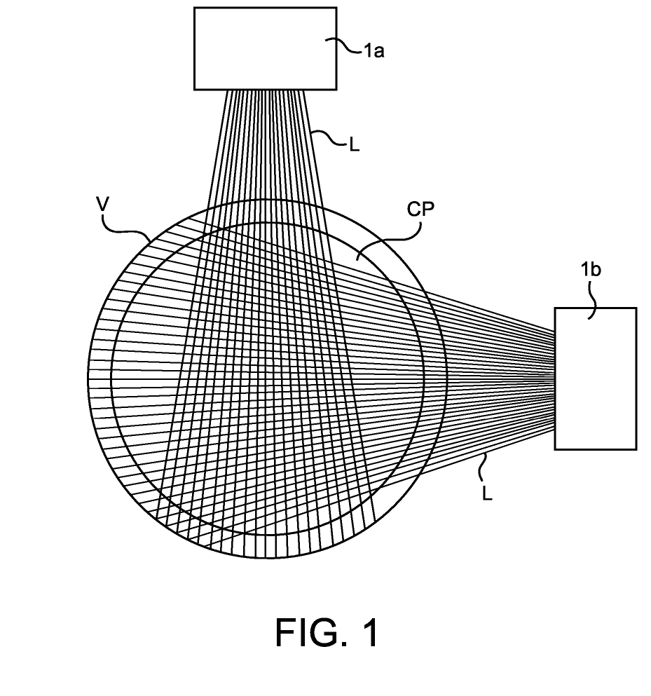

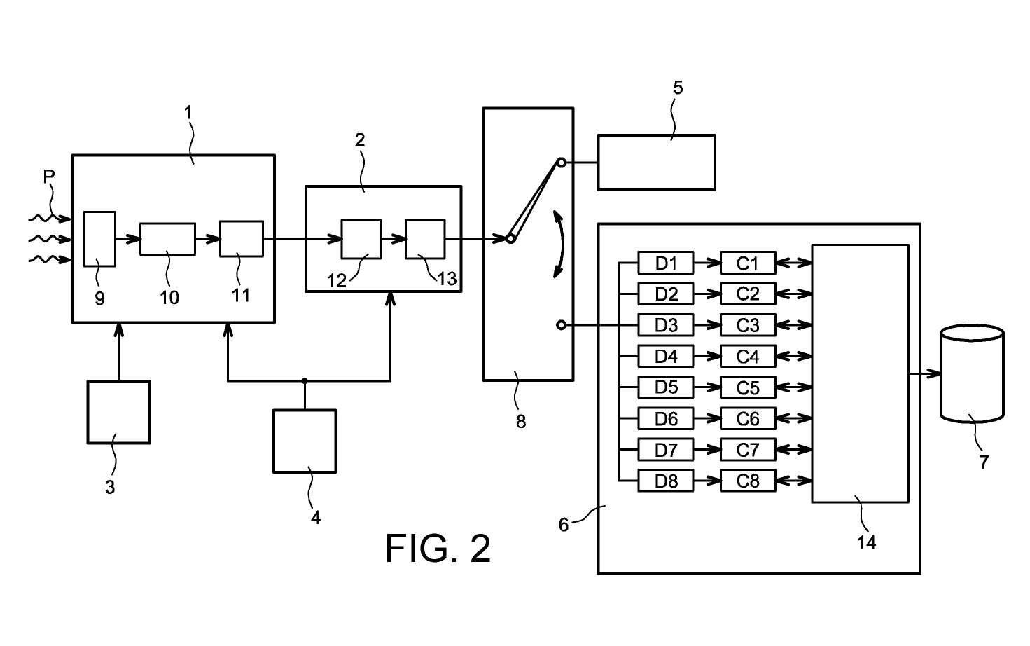

In all the figures, the same marks denote the same elements.

### DETAILED DESCRIPTION OF EMBODIMENTS OF THE INVENTION

The process according to the invention treats measurement data output from a real-time acquisition electronic circuit which is the subject of a French patent application entitled “Circuit électronique de diagnostic de spectrométrie” filed at the French Patent Office in the name of the Applicant with the filing number 04 50338, on Feb. 24, 2004.

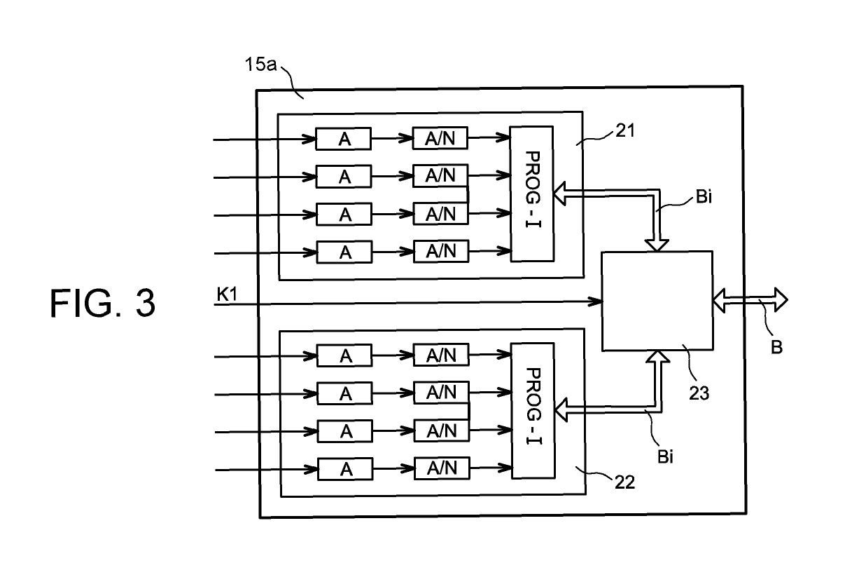

FIG. 3 represents an example of real-time acquisition electronic circuit which outputs the measurement data processed in the frame of the invention. The circuit 15a comprises two data processing modules 21, 22 and a programmable logic interface and control component 23. Each data processing module 21, 22 is connected to the programmable logic interface and control component 23 through a bus Bi. A data processing module 21, 22 may for example include four input amplifiers A in parallel, four analogue/digital (A/D) converters mounted in series with the four input amplifiers, and a programmable logic pulse processing component PROG-I. The programmable logic interface and control component 23 is controlled by a command K1 that controls the data acquisition rate. A VME (VERSA® Module Eurocard®) bus B outputs the measurement data to be processed by the process according to the invention.

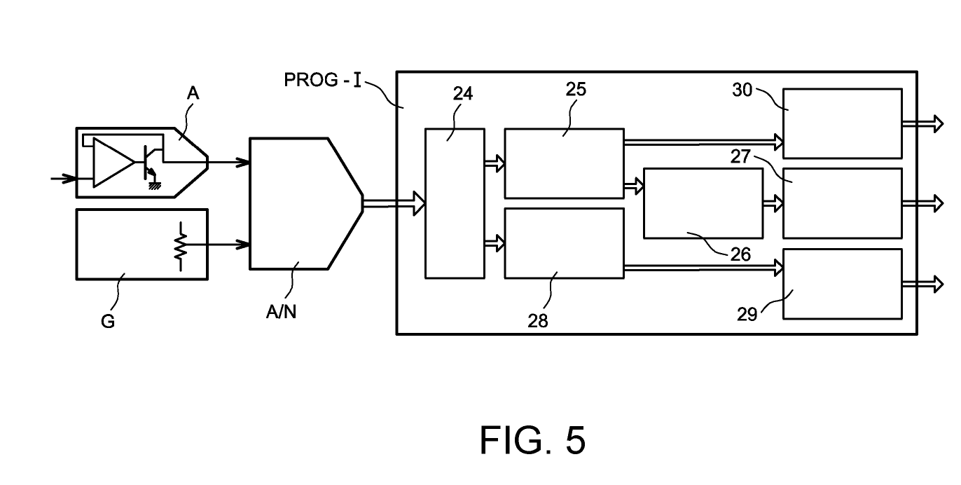

Each programmable logic pulse processing component PROG-I applies a set of operations on the digital data that it receives that are presented in more detail below with the description for FIG. 5.

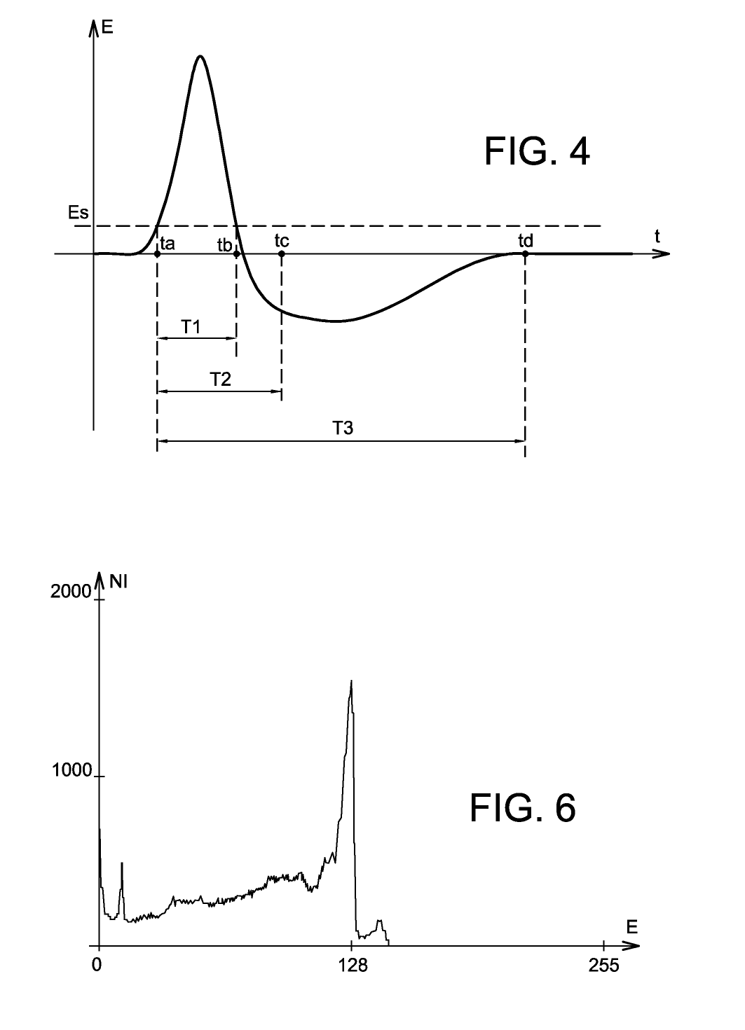

FIG. 4 is a typical representation of the signal which enters the real-time electronic circuit 15a.

The curve in FIG. 4 represents the energy E of the signal as a function of time t. The energy curve E comprises a positive pulse shaped part and a negative part. The “useful” part of the signal is the positive part. The duration of the positive part is of the order of one microsecond. The negative part, with duration of the order of a few microseconds (typically 3 or 4 μs) is due to the processing electronics. Several time parameters appear in FIG. 4 (ta, tb, tc, td, T1, T2, T3) that will be described in detail in the rest of the description.

FIG. 5 represents a detailed diagram of a processing module 21, 22.

A processing module 21, 22 includes several processing channels. FIG. 5 only shows a single processing channel composed of a single input amplifier A, a single analogue/digital (A/D) converter, a gain adjustment circuit G for the converter, and of the fraction of programmable logic pulse processing component PROG-I associated with it, for simplicity and to avoid complicating the figure.

The component PROG-I comprises the following function modules:
a pulse detection and amplitude measurement module 24,
a stack rejection module 25,
two energy slot sort modules 26, 28,
two digital count modules 27, 29 and
a histogram memory 30.

Apart from the amplification function, the input amplifier A performs an impedance matching function and eliminates the negative part of the received signal (see FIG. 4). The analogue/digital (A/D) converter quantifies the signal output by the amplifier A. The gain adjustment circuit G is used to program the converter gain through a VME bus. The converter gain is programmed during the calibration step. The processing module 24 firstly detects the pulses, and secondly measures the pulse amplitude. According to one preferred embodiment of the invention, a pulse energy threshold Es is used for detection (see FIG. 4), in order to eliminate noise on the measurement. Pulses for which the energy level is greater than or equal to the threshold Es are accepted, while pulses for which the energy level is lower are eliminated. When a pulse has been accepted, its width T1 is measured (see FIG. 4). The starting time from which the width of a pulse is measured is the time ta at which the pulse energy goes above the threshold Es. The time tb at which the pulse amplitude drops below the threshold Es is then used to define the width T1 of the pulse, that is written:
T1=tb−ta

A pulse width time threshold tc is used to sort pulses as a function of their width. The maximum pulse width T2 (T2=tc−ta) may then for example be equal to 1.5 μs.

The starting time ta from which the pulse width is measured is also the starting point of a programmable time T3 during which any new pulse is not counted. For example, the time T3 may be equal to 5 μs. The programmable time td that limits the time T3 (T3=td−ta) may for example correspond to the time at which the original pulse, in other words the pulse before elimination of its negative part, returns to approximately zero (see FIG. 4).

The stack rejection module 25 rejects any pulse whose width exceeds the pulse width threshold tc, and during a programmed time interval, for example the interval T3, rejects any new pulse if a first pulse has been already detected. Pulses not rejected by the stack rejection module 25 are used and sorted by programmable energy slots (sort module 26). Energy slots may for example be equal to the following values:
[20 keV-40 keV[,
[40 keV-60 keV[,
[60 keV-80 keV[,
[80 keV-100 keV[,
[100 keV-120 keV[,
[120 keV-140 keV[,
[140 keV-160 keV[,
≧160 keV.

Pulses for each energy slot are then counted in the count module 27. For example, in the case in which there are eight energy slots as mentioned above, the count module 27 may include eight 12-bit counters, in other words one counter for each energy slot. Only the counter associated with the energy slot detected for the current pulse is incremented.

Detected pulses that were rejected are also sorted by energy slots such that all detected pulses are also sorted (sort module 28) and counted (count module 29).

The histogram memory 30 is then involved in calibration measurements. The electronic HXR diagnostic circuit is then put into calibration mode.

We will now describe the calibration process. Data acquisition from a known external stimulus (standard source) is started. The histogram memory 30 sorts the signal by calibration energy slot. A calibration energy slot may for example be of the order of 1 keV. Only sorted pulses after stack rejection are included here. Each pulse entering the histogram memory increments one memory cell corresponding to the maximum amplitude of its energy. It is then possible to search for the cell or group of cells in which the largest number of pulses is located. Action on the gain adjustment can then be used to automatically make this maximum coincide with the expected and known energy from the standard source, through the VME bus.

FIG. 6 shows an example of the contents of the histogram memory. The abscissa shows the different energy levels E and the ordinate shows the number NI of pulses collected for each energy level.

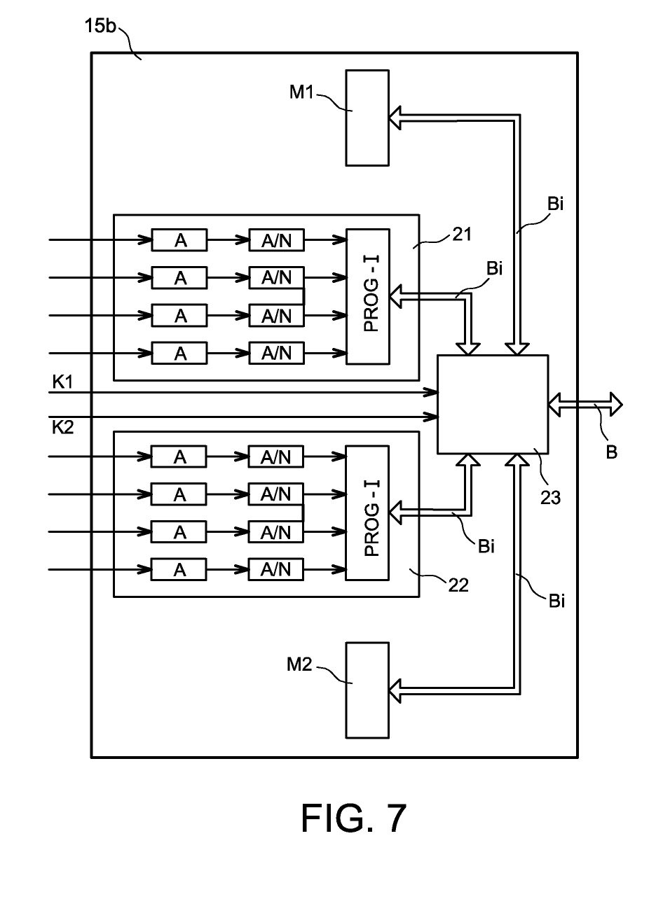

FIG. 7 shows an improvement of the real-time electronic circuit 15a.

Apart from the elements described above with reference to FIG. 3, the real-time electronic circuit 15b comprises two pull down buffer memories M1 and M2 that receive on their inputs digital data output by processing modules 21 and 22 respectively. A bus Bi connects each pull down memory M1, M2 to the programmable logic interface and control component 23. A command K2 applied to the programmable logic component 23 triggers storage of data output from processing modules 21 and 22 in the corresponding pull down memories M1 and M2. The pull down memories M1 and M2 may for example memorise the history of data output from A/D converters included in the corresponding processing modules 21 and 22 at a rate configurable through the VME bus B, or the history of changes to the states of counters 27, 29 at a rate configurable through bus B, this rate possibly being higher than the basic acquisition rate, so that changes to counters between two acquisitions can thus be observed.

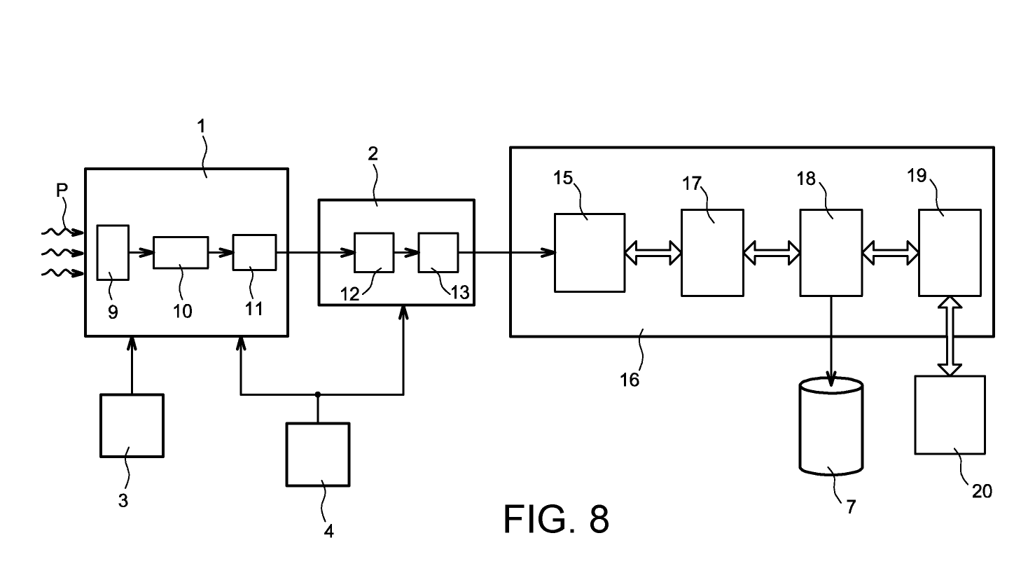

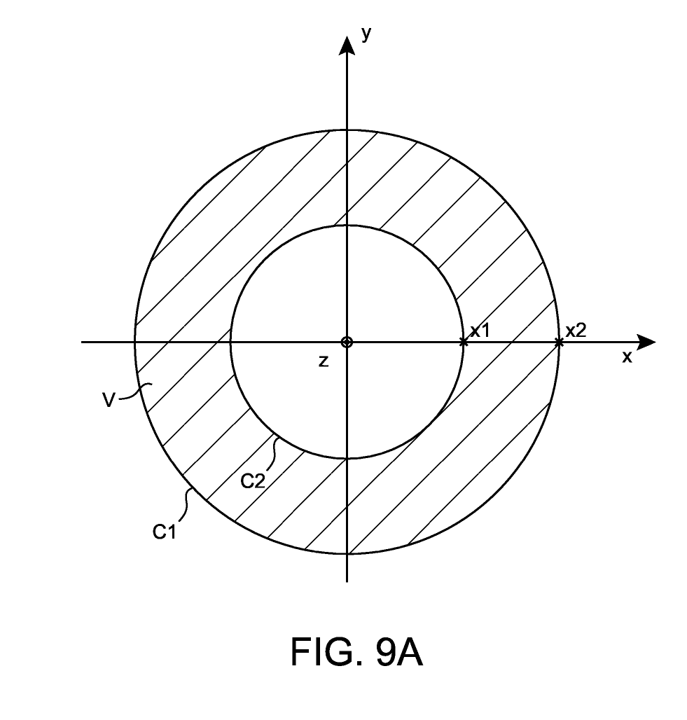

FIG. 8 represents an example of spectrometry diagnostic system with associated units which implement the process according to the invention.

The spectrometry diagnostic system comprises a camera 1, a receiver frame 2, a polarization circuit 3, a power supply circuit 4, a data processing circuit 16 and a data storage unit 7. The spectrometry diagnostic system according to the invention is distinguished from a spectrometry diagnostic system according to the prior art by the data processing circuit 16. The data processing circuit according to the invention comprises a real-time acquisition circuit 15 in series with a data acquisition and processing unit 17 and a management unit 18, all in series. The real-time acquisition circuit 15 is, for example, the circuit 15a represented in FIG. 3 or the circuit 15b represented in FIG. 7. The processing unit 17 and the management unit 18 implement the process according to the invention. The data processing circuit 16 contains a shared RAM 19 (RAM: Random Access Memory). The shared RAM 19, for example a SCRAMNET card (SCRAMNET: Shared Common Random Access Memory Network) advantageously shares data with other acquisition units through a communication network 20. In particular, the shared RAM 19 reads in real-time the plasma coordinates comprising major radius value Rp, vertical shift Zp and plasma radius “a”.

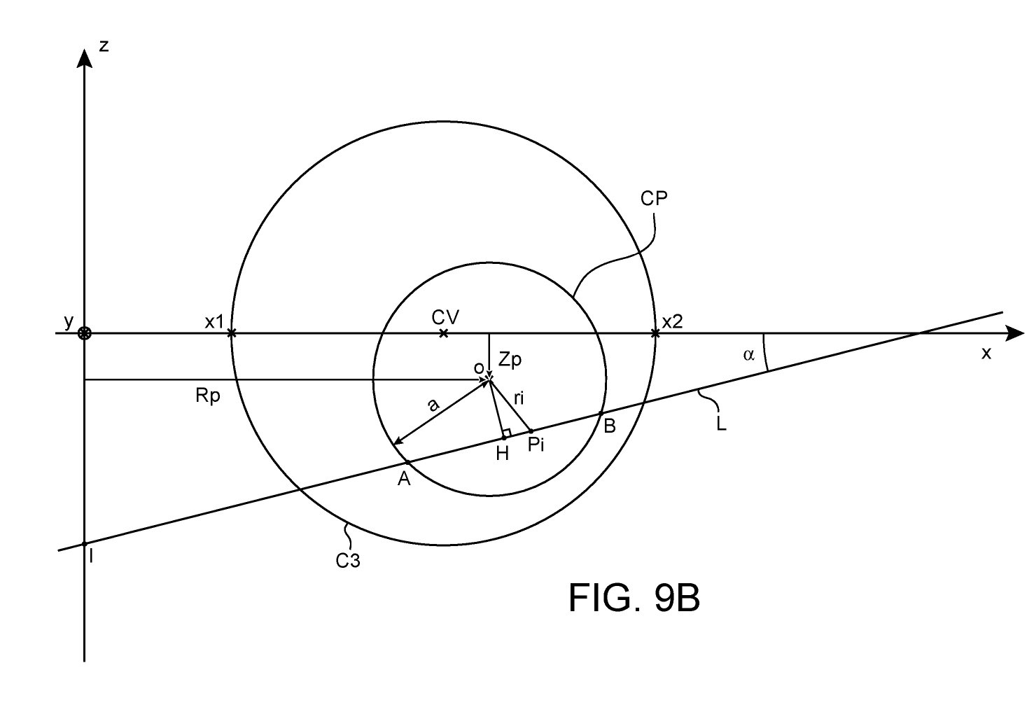

FIG. 9A represents a top view of a Tore Supra vacuum vessel placed in an orthonormal base (x, y, z) the centre (0, 0, 0) of which is the centre of the Tore Supra vacuum vessel and FIG. 9B represents a circular cross section of the Tore Supra vacuum vessel of FIG. 9A. The circular cross section of the Tore Supra vacuum vessel is contained in the plane (x, 0, z).

The top view of the vacuum vessel shows two concentric circles C1, C2 (see FIG. 9A) and the circular cross section of FIG. 9B is made of one circle C3. The x axis cuts circle C3 at points x1 and x2 and the centre coordinates of circle C3 in the orthonormal base (x, y, z) are (Cv, 0, 0). The circular cross section of plasma is a circle CP. Circle CP is off centre against circle C3. The coordinates of the centre O of circle CP in the orthonormal base (x, y, z) are (Rp, 0, Zp). Coordinates Rp and Zp are respectively called “plasma major radius” and “plasma vertical shift”. The radius of circle CP, commonly called “plasma minor radius”, is “a”.

For instance, only one line of sight L is represented in FIG. 9B. The line of sight L cuts the circumference of circle CP at points A and B. The distance between a point Pᵢ located on the line of sight L and the centre of circle CP is rᵢ. The point in the middle of segment AB is H. The line of sight L cuts z axis at point I. Calling α the angle between the line of sight L and the x axis, the slope T of the line of sight can be defined as T=tan(α), where “tan” is the tangent and α is with sign (positive or negative according to its position below or above the x axis).

As an example, the process according to the invention is now going to be described in the particular case where the points NL and NM are equally spaced. In order to properly understand the invention, it is first necessary to remind some basic theoretical elements and formulas. The subsequent assumptions have therefore to be done:

a) the description of the method will be done with just one line of sight;

b) the portion of a line of sight L between points A and B is subdivided into NL equally spaced points (according to the preferred embodiment of the invention, NL is between 20 and 30);

c) a normalized plasma radius ρ is subdivided into NM equally spaced points;

d) from c) it comes out that the final profile computed along the normalized plasma radius ρ is subdivided into NM equally spaced points as well;

e) the number of Bessel functions (see below) is NB (according to the preferred embodiment NB is equal to 6).

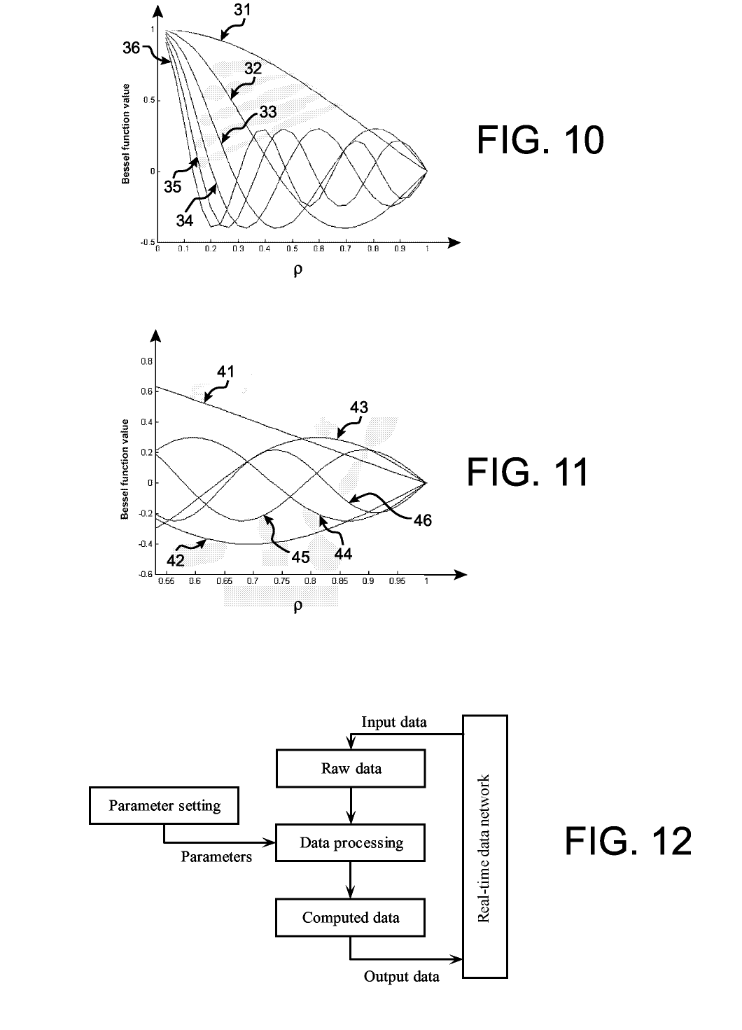

FIG. 10 shows, superimposed, the values of NB Bessel functions Jo of order 0 (NB=6), computed along NM equally spaced points of the normalized plasma minor radius ρ multiplied by Zᵢ (i=1, 2, . . . , NB), the Zᵢ's being the first NB zeros of the function Jo (31 is Jo(ρ*Z₁), 32 is Jo(ρ*Z₂), 33 is Jo(ρ*Z₃), 34 is Jo(ρ*Z₄), 35 is Jo (ρ*Z₅) and 36 is Jo(ρ*Z₆)). In the algorithm explanation, the matrix containing such values is called J_{ρ}.

FIG. 11 shows, superimposed, the values of the NB Jo's whose arguments are the distances rᵢ's from the geometric centre of the plasma (normalized with respect to the plasma minor radius “a”) of the NL points of the portion of the line of sight included in the plasma, multiplied by the NB zeros Zᵢ's. This picture is similar to the previous one: indeed if the line of sight coincides with the diameter of the circumference (plasma boundary) and if we consider only half the diameter (i.e. the radius “a”), FIG. 11 is the same as FIG. 10 (after having normalized the radius with respect to itself). Due to the symmetry of the distances with respect to the point H (see FIG. 9B), only half the values are displayed. In the same way as in FIG. 10, 41 is the curve related to Jo(ρᵢ*Z₁), 42 the curve related to Jo(ρᵢ*Z₂), and so on . . . , up to 46 the curve related to Jo(ρᵢ*Z₆), with i from 1 to NL. In the algorithm explanation, the matrix containing such functions is called J_{ρi}.

These are the formulas from where we start:
Y=N*A_{ρ} (1)
N=F*J_{ρ}⁻¹*EG (2)

where:
the Y's are the raw line-integrated measurements acquired by the camera's detectors (in equation (1), Y is a scalar, since for simplicity sake we are considering just one line of sight);
A_{ρ} is an array, the elements of which represent the local emissivity profile along a normalized plasma radius ρ;
N is a transfer matrix;
EG represents the geometrical extension of a detector;
J_{ρ} is a matrix of Bessel functions Jo of order 0 computed on the normalized plasma radius ρ (i.e. it varies between 0 and 1);
F is a matrix whose role is further explained.

In addition to the previous assumptions, also the following ones must be kept in mind:

f) all the length quantities, which are arguments of the Bessel functions, are normalized with respect to the plasma minor radius a;

g) the Shafranov shift, which is the displacement between the plasma geometric centre and the plasma magnetic centre, is negligible and not considered;

h) the local emissivity profile A_{ρ} is approximated with a superposition of NB Bessel functions Jo of order 0.

Assumption g) is important because it allows to avoid the calculation of the distance of each point from the centre of the flux surface to which it belongs (see reference [2]). Indeed this calculation should be done with an iterative method which is quite time consuming, while the calculation of the distance from the geometric centre is quite straightforward. Moreover assumption g) allows to reduce further the calculations, since it introduces a symmetry in the system. By means of this symmetry, the segment AH or the segment HB can be considered instead of AB as it will be further explained.

The calculation of the distances rᵢ's of the points Pᵢ from the centre is necessary since these are used as arguments of the Bessel functions in order to compute their values along the chords.

A proof that guarantees the possibility of exploiting assumption g) is the following. Let us consider the reconstructed local emissivity profile A_{ρ}. From this it is possible to determine the reconstructed line-integrated profile Y_{R} by means of expression (1):
Y_{R}=N*A_{ρ}

It is then easy to compute the chi-square χ² between the raw data Y and the reconstructed measurements Y_{R}. After a test made on several patterns of different pulses, it was seen that on average the χ² obtained without considering the Shafranov shift is comparable with the Shafranov shift one: on about 1000 samples from the TS database the χ² is 0.00155 in the first case and 0.00157 in the second (please note that the χ²'s have been computed with normalized profiles).

To exploit assumption h), the NB Bessel functions have to be computed on NB different arguments Args. For example if we consider Args equal to ρ*Z, where ρ is the normalized plasma radius, divided in NM points, and Z is an array whose elements are the first NB zeros of the Bessel function Jo of order 0, then:
Args=ρ*Z (3)

The NB Bessel functions computed on Args are shown in FIG. 10, and we decide to consider them as forming the matrix J_{ρ}, whose dimensions are NM*NB. The Z's are the first NB zeros of Jo, in crescent order from 1 to NB (6 in this example).

If we consider A(r/a) to be the local emissivity profile at a generic point P of the plasma at distance r from the plasma center then, due to assumption g), the profile A can be considered to have radial symmetry on the whole poloidal section and, following assumption h), each value of the local emissivity on each point Pᵢ(rᵢ/a) of the poloidal plane can be thought of as a linear combination of NB values of Bessel functions Jo calculated in Pᵢ(rᵢ/a). Therefore there are NB linear combination coefficients that are constant on the poloidal plane.

The line-integrated emission measured on a single chord can be expressed as:

$$\begin{matrix}Y = EG * {\int }_{A}^{B} A ( r / a ) ⅆ {r}_{a} \\ ≅ EG * \frac{D}{NL - 1} * {\sum }_{i = 1}^{NL} A ( {r}_{i} / a ) \\ = EG * {δ}^{′} {\sum }_{i = 1}^{NL} A ( {r}_{i} / a )\end{matrix}$$

where δ′=D/(NL−1) and D is the length of segment AB.

Expression (4) is particularly valid for a reasonably high number of points, as the default value is, and it can be also rewritten (keeping in mind the definition of A_{ρi}) as:
Y=Δ*A_{ρi} (5)

where Δ is a row matrix of dimensions 1*NL such that:

Δ=[δδ . . . δ], with δ=δ′ EG

Due to assumption h), we also have that

$$\begin{matrix}A ( {r}_{i} / a ) = {\sum }_{j = 1}^{NB} {c}_{j} * {J}_{0} ( ( {r}_{i} / a ) * {Z}_{j} ) \\ = {\sum }_{j = 1}^{NB} {c}_{j} * {J}_{o} ( {ρ}_{i} * {z}_{j} ) \\ = J ( {ρ}_{i} ) * C ,\end{matrix} \qquad ( 6 )$$

where J(ρᵢ) are the values of the NB Bessel functions computed in ρᵢ; a typical trend of them along a line of sight is shown in FIG. 11. Here, a value of 1 on the horizontal axis means that rᵢ/a=1 and so that J(ρᵢ) has been computed on the plasma boundary. It can be seen that all the values of J(ρᵢ) on the plasma boundary are forced to be 0 (multiplication of rᵢ/a=1 by the zeros Zⱼ's) and that only the values on half the chord have been computed.

Then, considering that J_{ρi}=[J(ρ₁), J(ρ₂), . . . , J(ρ_{NL})] and, from (5), that A_{ρi}=[J(ρ₁)*C, J(ρ₂)*C, . . . , J(ρ_{NL})*C]=J_{ρi}*C, substituting this expression in expression (5) yields
Y=K*J_{ρ}_{ᵢ}*C (7)

Considering expressions (4), (5) and (7) it turns out that the values of the array Δ*J_{ρi} are nothing but the integrals of J_{ρi} along a line of sight. The above mentioned array Δ*J_{ρi} is what we previously called F. Therefore:
Y=F*C (8)

From assumption h) we can also write, similarly to expression (6):
A_{ρ}=A(ρ)=J_{ρ}*C (9)

where A_{ρ} is the profile along ρ that we are looking for. From expression (9) it turns out that:
C=J_{ρ}⁻¹*A_{ρ} (10)

After having substituted expression (10) in expression (8) the result is the following:
Y=F*C=F*J_{ρ}⁻¹*A_{ρ}=N*A_{ρ} (11)

Remembering that we have already included EG in Δ, i.e. in F, it turns out that expression (11) is nothing but expression (1).

Therefore the unknown local emissivity profile A_{ρ} is given by:

$${A}_{ρ} = \frac{{J}_{ρ} * {F}^{- 1}}{EG} * Y = M * Y \qquad 12 )$$

where we extracted EG from F.

Actually, expression (12) is not correct because its dimensions must be adjusted. The final expression for the local emissivity profile is therefore:

$${A}_{ρ} = \frac{{J}_{ρ} * {F}^{- 1}}{EG * 1000} * Y = \frac{M}{1000} * Y \qquad ( 13 )$$

The way the expression (13) is obtained is given by the following explanations.

The raw line-integrated measurements Y can be defined as the number of photons hitting the detector per unity of energy and of time:

$$Y = \frac{{N}_{PH}}{E * t} = \frac{number\_of \_photons [ ]}{energy [ eV ] * time [ s ]} \qquad ( 14 )$$

where the quantities in parentheses are the physical dimensions (eV are electron-volts and s are seconds). The local emissivity profile A_{ρ} can be instead defined as the number of photons hitting the detector per unity of energy, of time, of volume and of solid angle:

$$\begin{matrix}{A}_{ρ} = \frac{{N}_{PH}}{E * t * V * Ω} \\ = \frac{number\_of \_photons [ ]}{energy [ eV ] * time [ s ] * volume [ {mm}^{3} ] * solid\_angle [ str ]}\end{matrix} \qquad ( 15 )$$

Here in particular we have that V is in mm³ and Ω in str (steradiants). Considering expressions (1), (2) and (15), and that EG is in mm²*str, we can write for Y the following expression:

$$Y = \frac{{N}_{PH}}{E * t} = EG [ {mm}^{2} ] [ str ] * F * {J}_{ρ}^{- 1} [ m ] * {A}_{ρ} \qquad ( 16 )$$

F*J_{ρ}⁻¹ is in meters, since this quantity is an integral of an adimensional quantity (Bessel functions) along a distance in meters (F), multiplied by an adimensional quantity (J_{ρ}⁻¹). Expression (16) is not dimensionally correct, because keeping in mind expression (15) └mm²┘*[m]≠└mm³┘. Indeed we must have millimeters instead of meters. This is why we must multiply Y by 1000: m*1000=mm.

It turns out that the final formula for Y is:
Y=1000*EG*F*J_{ρ}⁻¹*A_{ρ}=1000*N*A_{ρ}. (17)

If we compare expression (17) with expressions (1) and (2), we can suppose that in expression (2) the factor 1000 has been included in EG. The final formula for A_{ρ}, on the other hand, is:

$${A}_{ρ} = \frac{{J}_{ρ} * {F}^{- 1}}{EG * 1000} * Y = \frac{M}{1000} * Y \qquad ( 18 )$$

Thus formula (18) is identical to formula (13).

The overall scheme of the real-time computation process used to get the local emissivity profile can be seen in FIG. 12; five main logic parts form it:
a real-time data network used to exchange data (communication network 20 in FIG. 8)
the raw input data;
the parameters necessary to the process (see below);
the data processing, which is the core of the real-time process;
the computed output data.

The output data sent to the real-time network will be then used to achieve the feedback control of the plasma by means of the control system.

The real algorithm, in its turn, can be subdivided into two main parts:
parameter setting, which is done before each experimental session;
raw data processing, which allows to get the real-time emissivity profile from previously defined parameters and from raw data coming from the electronic cards.

For the parameter setting part, the following data must be provided by the operator:
a mask with a selection of the chords to be used (in the case that not all the 59 chords are available);
the cut-off frequency used to filter the integrated raw data before the data processing, and the threshold used to assess the goodness of the profile by means of the χ² computation;
the minimum number of photon counts/s that is considered acceptable for each chord;
a flag to select the option to filter the integrated raw data;
a flag to select the option to compute an average (over a fixed number of time samples) of the input patterns (see below);
the maximum number of acceptable local maxima of the final computed profile (see below).

For the data processing part, the algorithm can be divided into three main parts:
the part dedicated to initialize the code at the very beginning of each discharge;
the part dedicated to compute the SE local emissivity profile which, in its turn, is formed by the following main steps:
initialization of the main program variables;
reading of input data;
data pre-elaboration;
change of coordinate center;
calculation of chord intercepts with plasma boundary;
computation of matrix F;
determination of the local emissivity profile A_{ρ};
check of local emissivity profile A_{ρ};
computation of reconstructed integrated data Y_{R};
determination of chi square χ² between Y and Y_{R}.
the part devoted to write the output data.

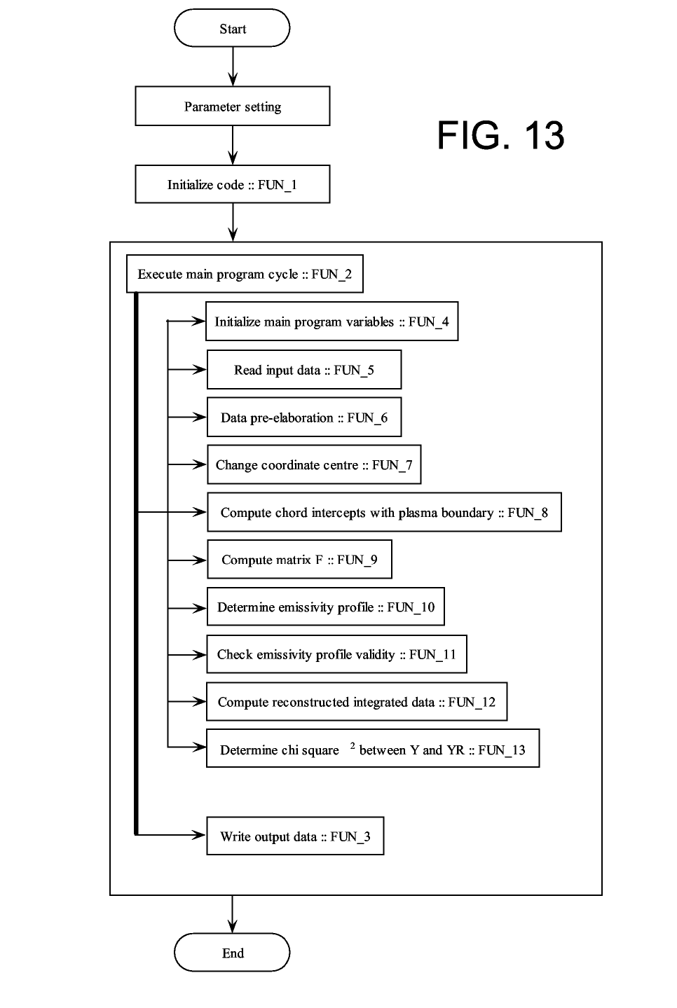

What described just above is presented in FIG. 13.

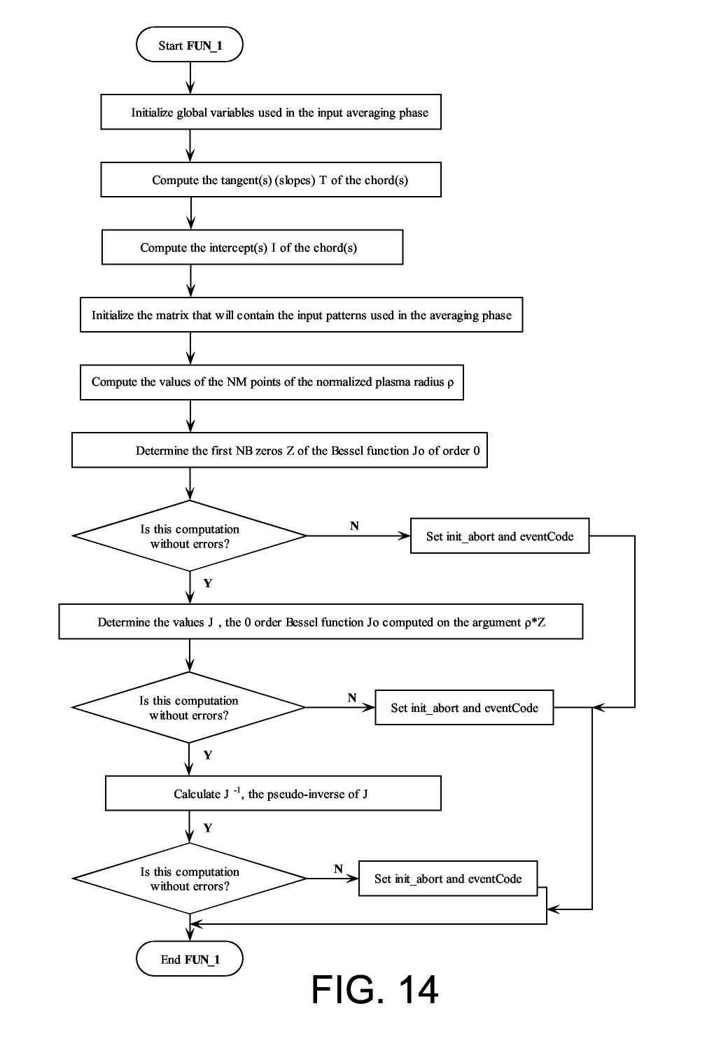

The whole process begins, before the actual execution of a discharge, by changing, if necessary, some parameters, relevant to the process, by means of a graphical interface (even if, once they are tuned, they should not be necessarily changed anymore). These parameters are read by the control system (CS) at the very beginning of a pulse. In the preliminary phase of a pulse the control system arranges also for initializing the main quantities used in the process: this is achieved by invoking FUN_1 (see FIG. 14). Then, when the discharge actually begins, the CS invokes FUN_2, which is the main routine, executed at every cycle of the control process.

The main body of the algorithm starts by checking if the main initialization phase ended with errors; in this case an event is registered and FUN_2 ends (Cycle Error Procedure—CEP), else it goes on and arranges for initializing the variables used during a cycle (FUN_4). From this point up to the end of the main body of FUN_2 any reference to a CEP call will be omitted, since it is assumed that, except FUN_4, there is an error checking (and so a possible CEP) after the call of every function. The subsequent step is to read the algorithm data from the input buffer (FUN_5); after that, the program has to perform some data pre-treatment (FUN_6). Then the change of system coordinate must take place, which in particular acts on the intercepts I of the lines of sight with the axis z (FUN_7). At this point the intercepts I_{P} of the chords with the plasma boundary can be computed (FUN_8). They are needed to calculate the arguments of the Bessel functions Jₒ(ρᵢ*Zⱼ) (see FIG. 11 and expression (6)), whose integrals, computed by means of a standard routine, will constitute the matrix F (FUN_9). But, to determine the profile A_{ρ}, the pseudo-inverse of F. F⁻¹, is needed (see expression (13)): this can be computed with a standard pseudo-inversion routine. Now it is possible to compute the profile A_{ρ} for the current cycle (FUN_10), but then the consistency of the just computed profile must be verified (FUN_11). Having A_{ρ}, it is then possible to determine the reconstructed line integrated measurements Y_{R} (FUN_12) and to use them in conjunction with Y to work out the chi-square χ² between them (FUN_13). This quantity is subsequently used as final assessment to the goodness of A_{ρ}: if also this check has passed, the SE local emissivity profile will be made available to the real-time feedback control. This is done in FUN_3, which forms the writing body of FUN_2, where all the data are arranged in the output buffer in order to be recorded in the database and to be used in the feedback system.

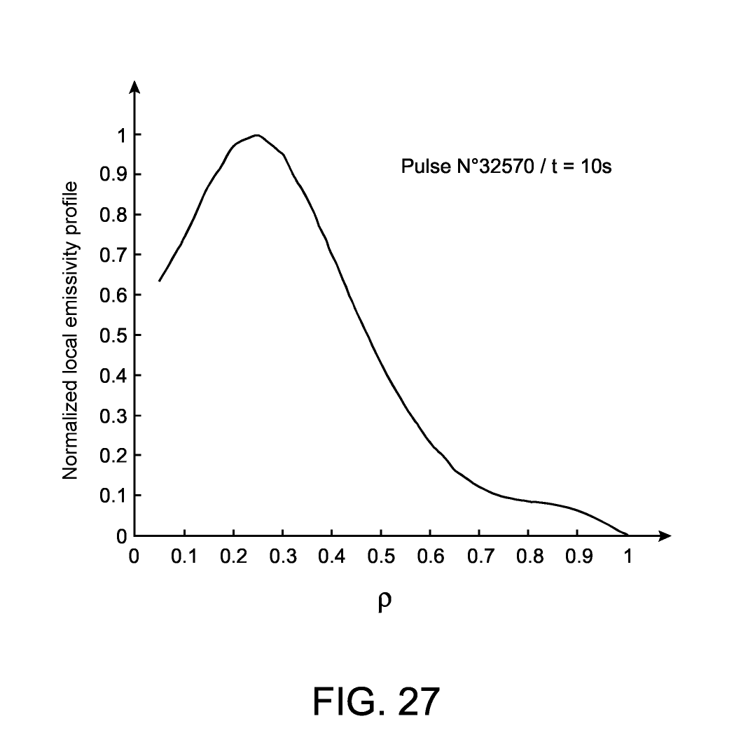

A concrete result of this algorithm can be seen in FIG. 27, where the SE local emissivity profile is shown computed from the HXR data of one TS discharge (for example discharge no 32570) at a given time (for example t=10 s).

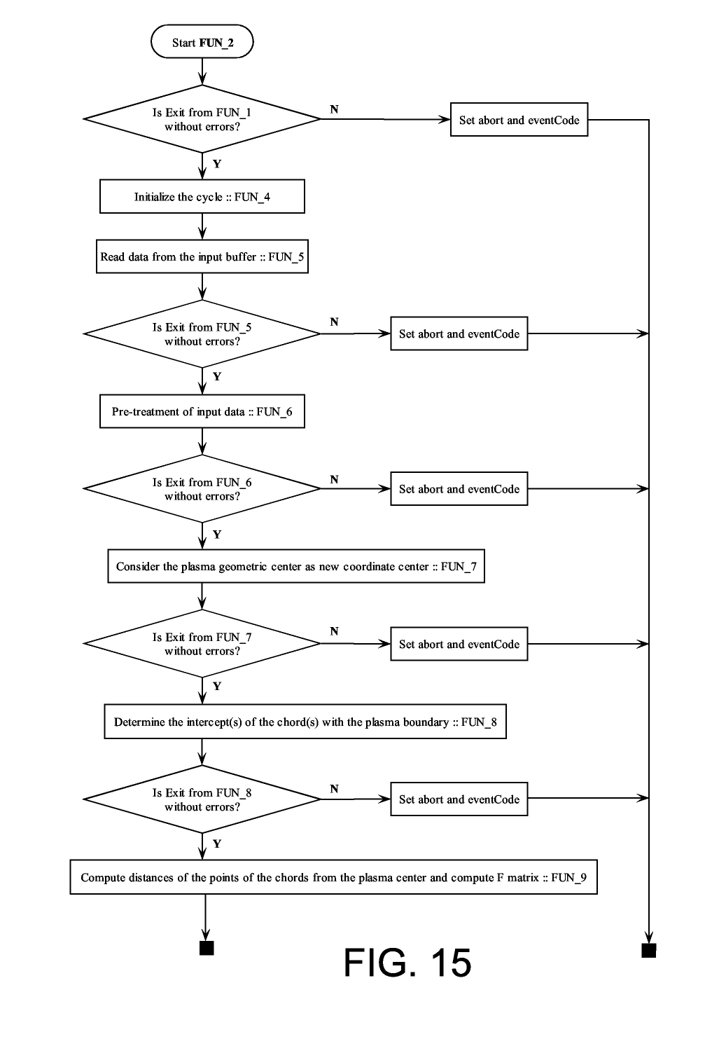

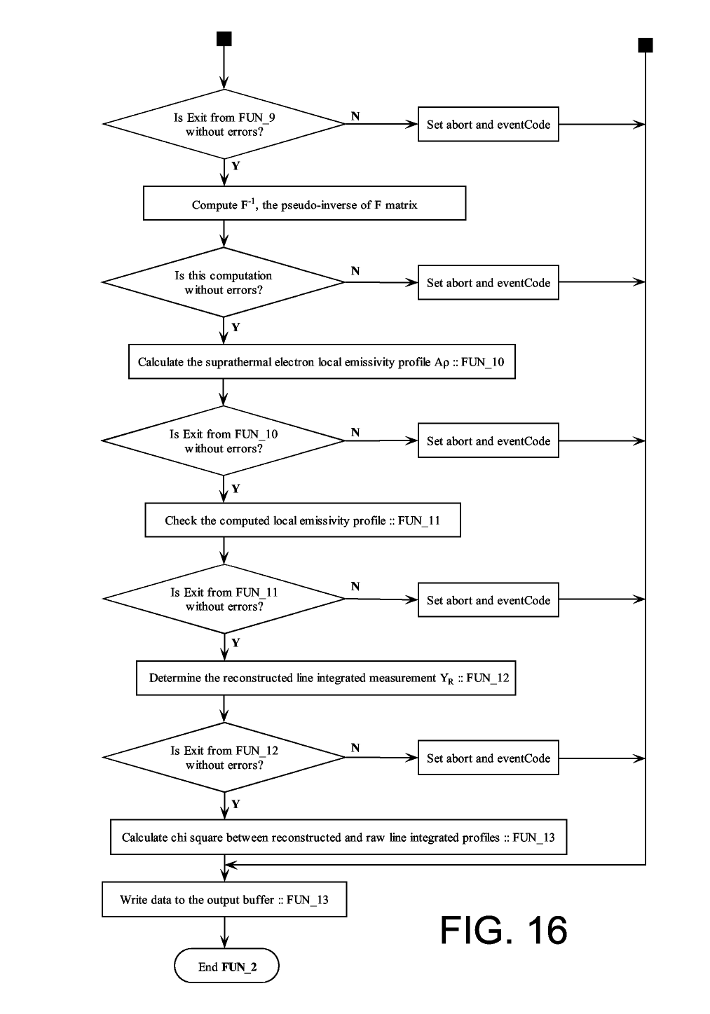

The following part is devoted to the explanation of the code as it has to be implemented on a real-time system. The code is made of 13 functions and is reported from FIG. 13 to FIG. 26 under the form of a pseudo-language and using basic flow charts. In the pictures, the functions appear with symbolic names (FUN_N, where N=1, . . . , 13). Apart from FIG. 13, each figure shows the flow chart of a function (FUN_2 has been split into FIGS. 15 and 16). Only FUN_4 is not reported: the reason is that this function makes only simple initializations of variables at the beginning of each cycle (i.e. each time FUN_2 is invoked).

The symbolic names are linked to the actual implemented functions in the following way:

FUN_1=initSPX (FIG. 14);

FUN_2=calSPX (FIG. 15-16);

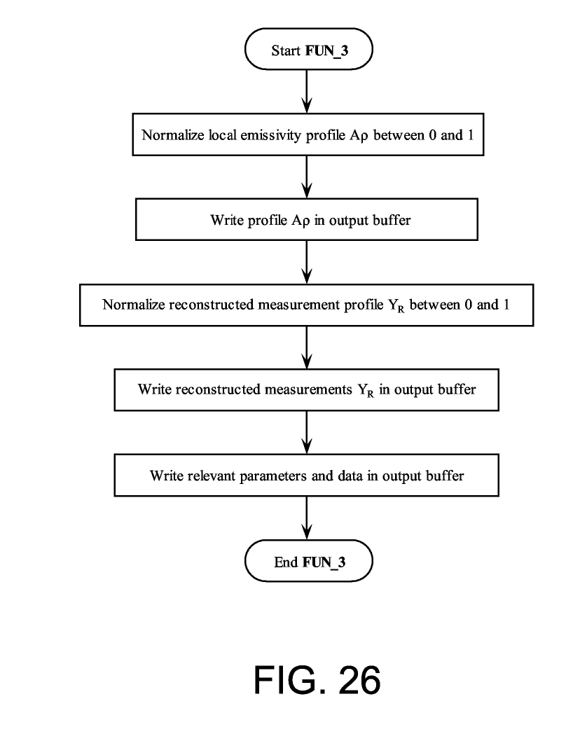

FUN_3=writeDataSPX (FIG. 26);

FUN_4=cycleInitSPX (no figure);

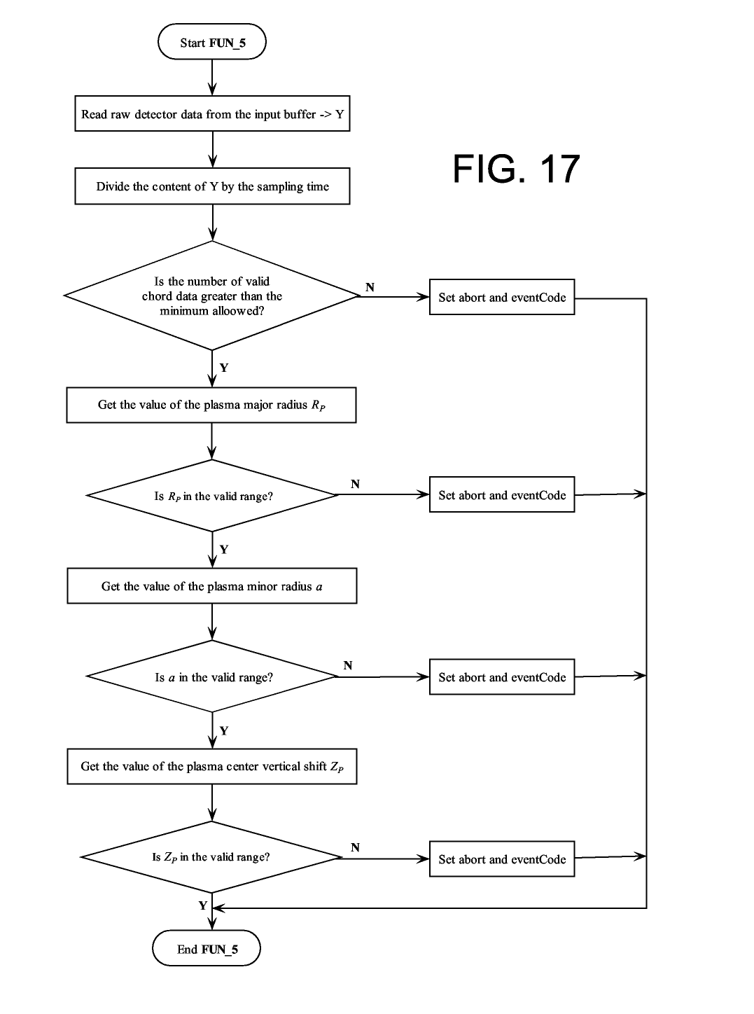

FUN_5=readDataSPX (FIG. 17);

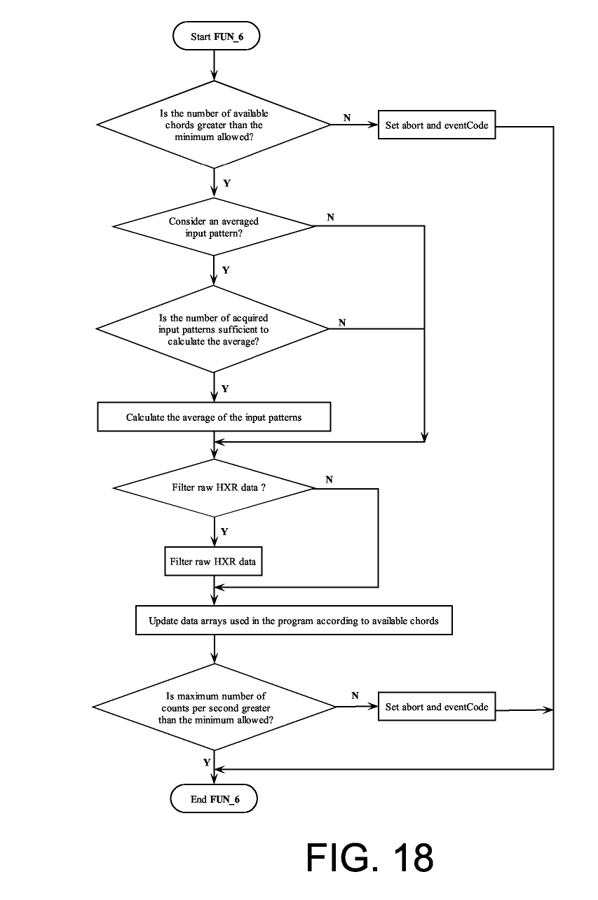

FUN_6=preElaborationSPX (FIG. 18);

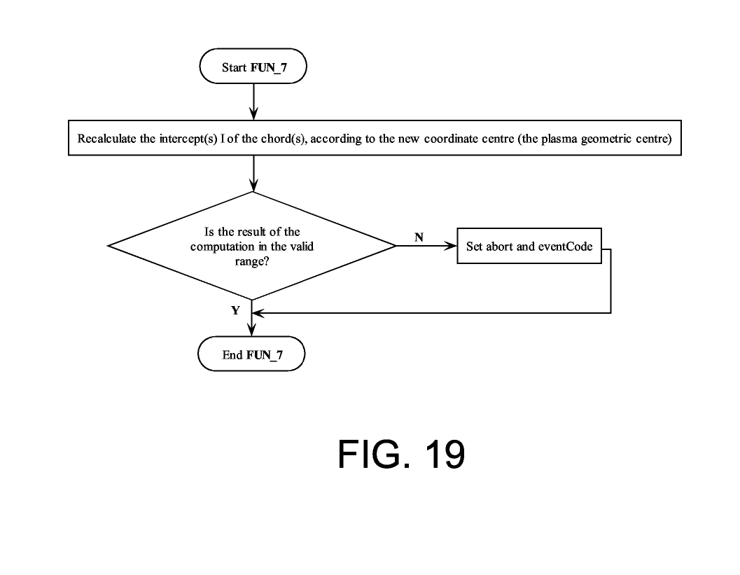

FUN_7=newCoordCenterSPX (FIG. 19);

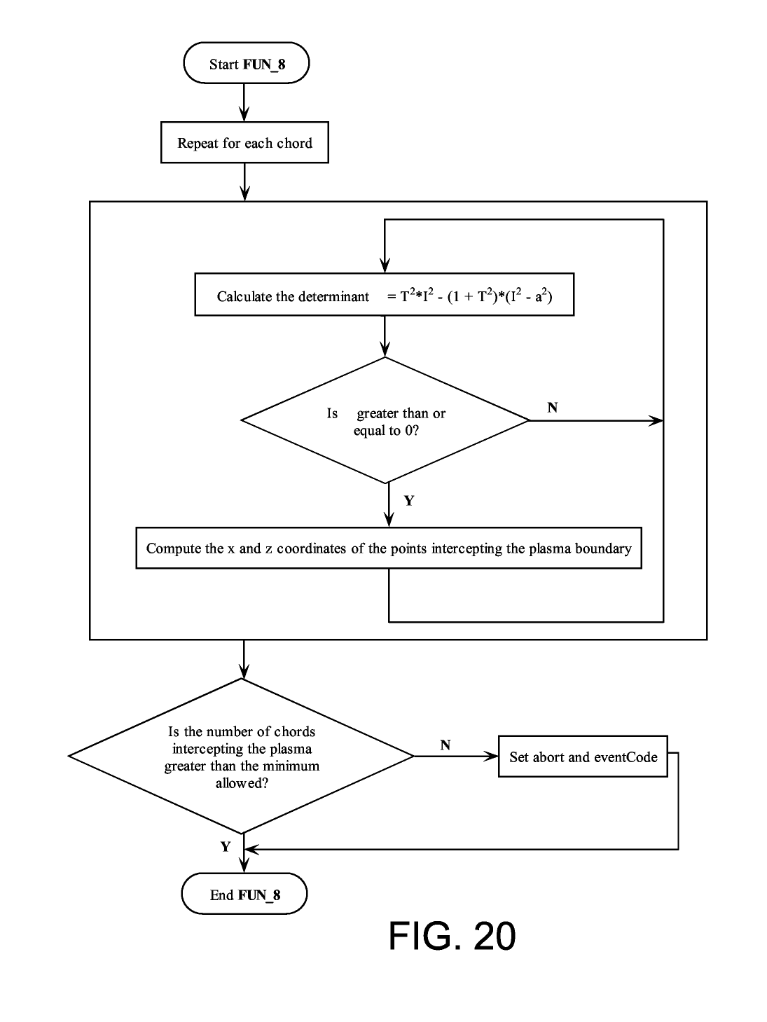

FUN_8=lcfsInterceptSPX (FIG. 20);

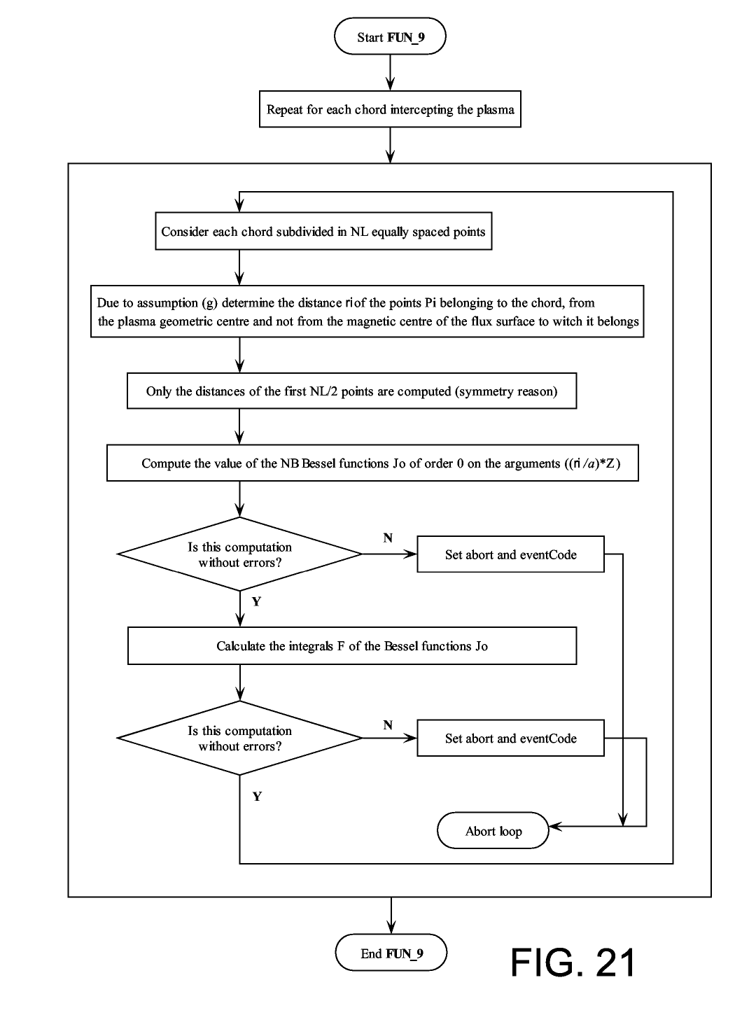

FUN_9=computeRFMatricesNoMagSPX (FIG. 21);

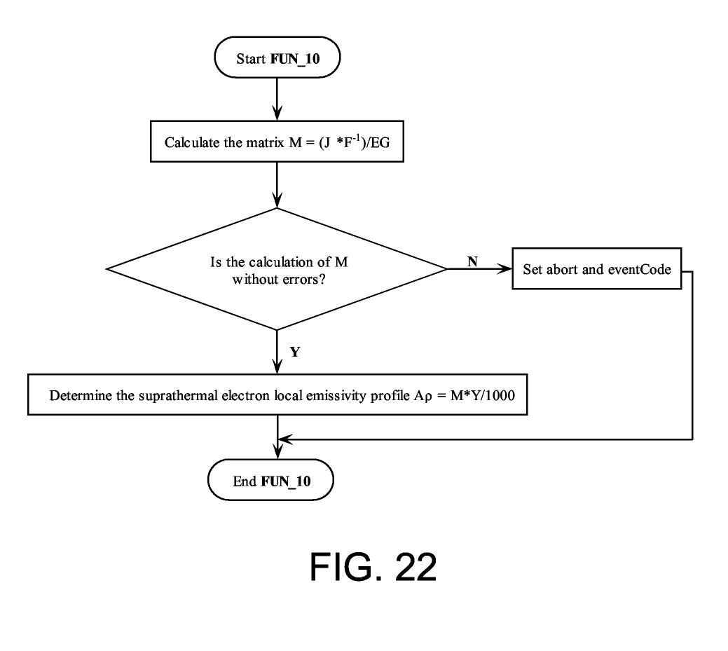

FUN_10=computeProfileSPX (FIG. 22);

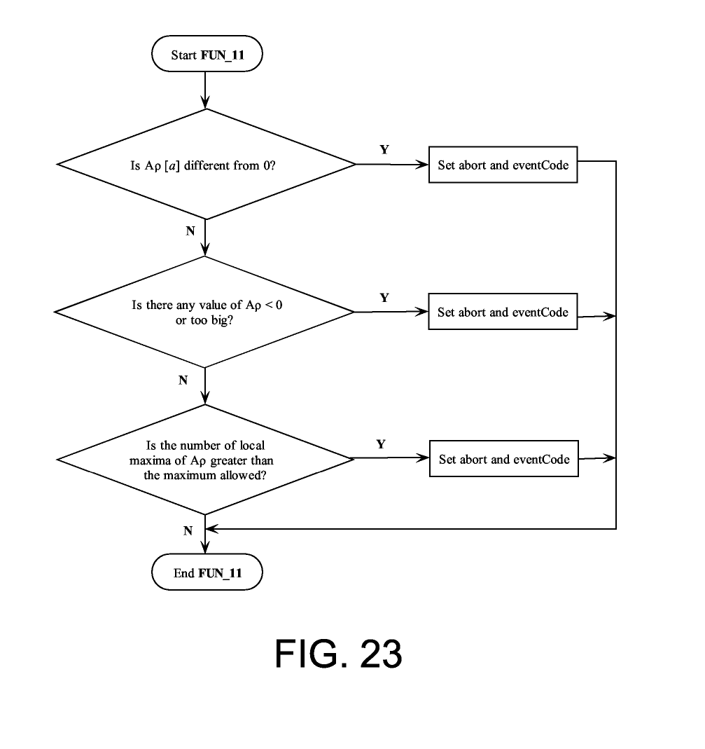

FUN_11=checkProfileSPX (FIG. 23);

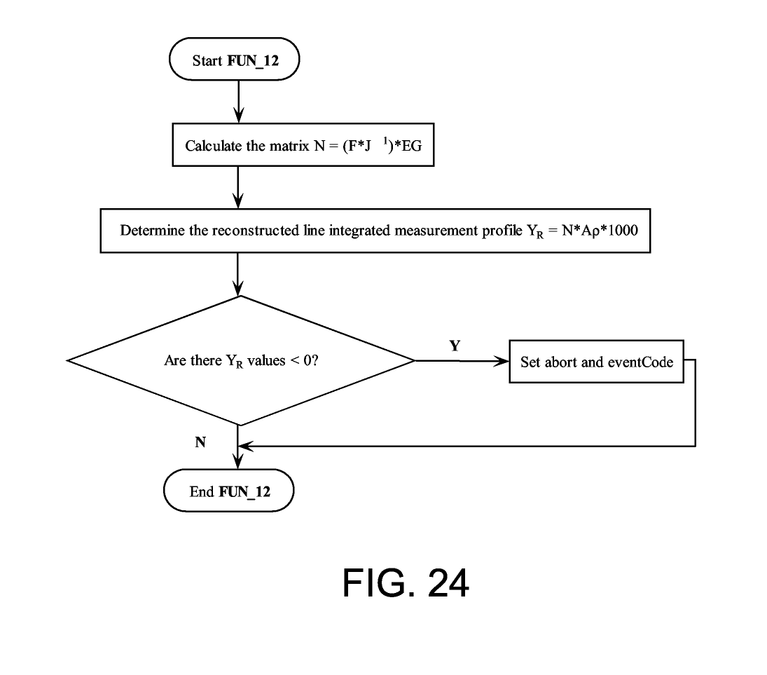

FUN_12=computeIntegratedDataSPX (FIG. 24);

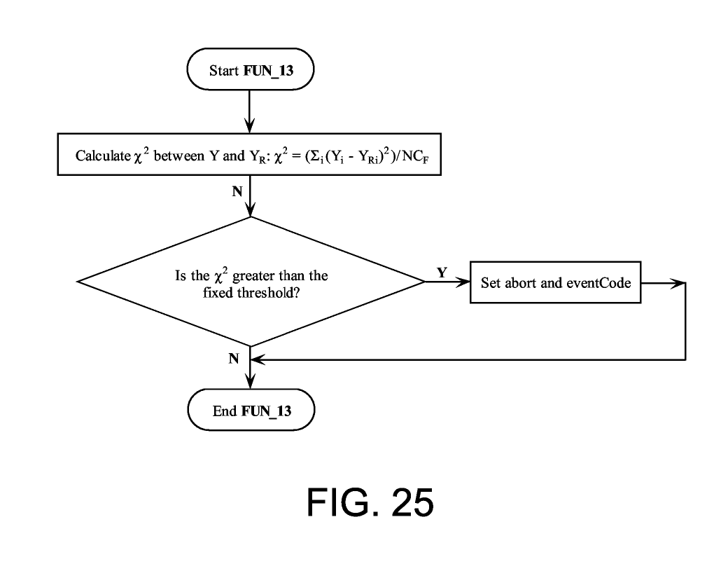

FUN_13=computeChiSquareSPX (FIG. 25);

FIG. 12 gives an overview of the real-time computation process: a real-time data network is needed, where to exchange a part of the input data and all the output data. Then the block with the raw input data is highlighted: it contains both the raw HXR data supplied by the spectrometric diagnostics and the data related to the geometry of the plasma. The raw data are used of course as input by the algorithm during the real-time data processing phase, but before, at the very beginning of each discharge, there is the phase in which it is possible to change some algorithm parameters: for example it is possible to modify the chords with which the SE local emissivity profile is computed. At last, the block with the computed output data is highlighted.

FIG. 13 gives a global view of the algorithm and shows all its basic steps. In the first step some fundamental algorithm parameters are written into the memory of the hardware by means of a graphical interface before the actual execution of the main parts of the code, i.e. before a plasma discharge. The second step represents the code initialization phase before a plasma discharge, and it is explained in FIG. 14. The third step is the main part of the algorithm, the one executed every cycle of the real-time control process (it is analyzed in detail in FIGS. 15 and 16). This can be divided into 2 parts: one devoted to the computation of the SE emissivity profile, the other devoted to write the output data that will be used for the feedback control (FIG. 26). The part devoted to the computation of the profile, in its turn, can be subdivided into several branches, each of which performs a different task: initialization of main program variables, reading of input data (FIG. 17), data pre-elaboration (FIG. 18), change of coordinate centre (FIG. 19), calculation of chord intercepts with plasma boundary (FIG. 20), determination of integrals of Bessel functions along the chords (matrix F—FIG. 21), determination of the SE local emissivity profile (FIG. 22), check of emissivity profile (FIG. 23), determination of reconstructed integrated data Y_{R} (FIG. 24), computation of chi square χ² between Y and Y_{R} and final assessment of the local emissivity profile (FIG. 25).

In FIG. 14, FUN_1 is shown and this is what is called initSPX in the code. This is the function, called before a discharge, needed to initialize some important quantities. At its beginning some global variables used in the input averaging phase (see FIG. 18) are set to 0. Then, supposing that each line of sight represents a straight line, the chord tangents T (slopes) and interception points I are computed. Indeed, these quantities are needed to calculate the interception points of the chords with the plasma boundary and consequently the distances of their points from the plasma geometric center (see also FIGS. 9A/9B). For the averaging phase a store matrix is needed to keep data from the last N_AV patterns (see FIG. 18 for an explanation of the averaging phase). The next steps are to calculate the values of the NM points of the normalized plasma radius ρ (assumption c)) and the computation of the first NB zeros of the Bessel function Jo of order 0. Indeed, these zeros are needed to prepare the arguments for J_{ρ} (see expression (9) and FIG. 10) and J_{ρi} (see expression (6) and FIG. 11). If this computation is with errors, then an abort_from_initialization flag is set to 1, the event is registered and the execution of FUN_1 ends (initialization error procedure—IEP), otherwise the next step is the computation of J_{ρ}. This is done in the initialization phase since this matrix is constant throughout all the pulses. If this computation is with errors, then the IEP is executed, otherwise J_{ρ}⁻¹, a (constant) matrix that is necessary to compute the reconstructed line measurements Y_{R} (see expressions (2) and (11)), is computed. If this caused any error then IEP is executed, otherwise FUN_1 terminates without errors.

FIG. 15 displays the first part of FUN_2, which is the main routine of the whole process, in the sense that all the subroutines necessary for the determination of the SE local emissivity profile are invoked by it. If the exit from FUN_1 was with no errors, this function is executed every cycle.

FUN_2 can be divided into two parts: the first one concerns the calculation of the SE emissivity profile and of the quantities related to it (main body); the second one has to do with the writing of the output data (writing body). While the main body may or may not be executed, or just may be partly executed, the writing body is always executed. FUN_2 actually starts checking the abort_from_initialization flag and, if this is equal to 1, it sets to 1 the abort_cycle flag too, it registers the event and it ends the main body (cycle error procedure—CEP). Instead, if the exit from FUN_1 was good, there is the first step of the main body for the computation of the emissivity profile, i.e. the initialization of the parameters that are renewed every cycle, like for example the array containing the raw data acquired by the diagnostics (FUN_4). Since FUN_4 cannot give errors, straight after it there is the reading of the raw data (FUN_5), which includes the HXR ones, the plasma major and minor radii (R_{P} and a) and the plasma vertical shift Z_{P}. From this point onwards, each function call in FIG. 15 can give raise to a CEP, so this issue will not be considered anymore in this paragraph. After the FUN_5 call, the next step is to pre-elaborate the HXR raw data (FUN_6). The main purpose of the latter function is to filter the raw data, in order to decrease the side effects due to noise. It is then time to consider the shift of the coordinate system centre from (Cv, 0, 0) to the plasma geometric center (Rp, 0, Zp) (FUN_7) and to determine the interception points of the lines of sight with the plasma boundary (points A and B in FIG. 9B). This is achieved with FUN_8, whose rationale will be discussed below. The final step of FUN_2 (concerning FIG. 15) is to compute the F matrix (see expression (8)) by means of FUN_9.

FIG. 16 reports the second part of FUN_2. Also here each function of the main body can cause a CEP. After the computation of F, its pseudo-inverse, F⁻¹ (see expressions (12) and (13)), must be computed. Then all the instruments to determine the SE local emissivity profile are available and so FUN_10 is invoked. The just computed emissivity profile must be analyzed, to check its goodness, and this is the aim of FUN_11, while purpose of FUN_12 is to determine the reconstructed line measurements Y_{R}. This quantity can then be compared with Y (FUN_13) in order to supply a further check on the goodness of the emissivity profile. After FUN_13 the main body of FUN_2 ends; independently of the outcome of FUN_13 (either with CEP or not), the routine FUN_3 of the writing body is called, whose aim is to write all the useful data to the output buffer.

The first important operation executed in FUN_2, after the initialization of cycle variables by FUN_4, is the reading of algorithm data from the input buffer. This is the duty of FUN_5, whose flow chart is shown in FIG. 17. At first the code gets the raw detector data from the input buffer and puts them in Y. At this point Y contains the number of counts acquired in a sampling period, but what is important is the number of counts per second (counts/s), so the second step is to update Y dividing the raw detector data by the sampling time dT. If the number of chords whose value is good for computation is less then a fixed minimum, decided a priori, the function calls a CEP, otherwise FUN_5 goes on and reads the values of the current plasma major and minor radii (respectively R_{P} and a) and of the plasma vertical shift Z_{P}. After the acquisition of each of the three parameters, there is a check on if their value is within the validity range; if this is not the case, a CEP is executed. The function ends with the check on Z_{P}.

The step after reading data from the input buffer is filtering the detectors' raw signals, in order to avoid problems due to statistical noise. This is the purpose of FUN_6 (see FIG. 18), where the solution consists either a) in averaging the inputs or b) in filtering the raw data with a low-pass filter. Both operations are not mandatory and their execution can be decided by setting, before a discharge, two proper flags during the already mentioned parameter setting phase.

Anyway, FUN_6 must also check that the number of currently used chords is greater than the minimum allowed (the minimum allowed number of chords MNC is a value embedded in the code), and this is the first operation executed in it. If this is not true, the function executes a CEP, otherwise FUN_6 checks the flag for the averaging phase.

The averaging phase is executed if its flag is 1; it consists in averaging a certain number NIP of input patterns (this number is embedded in the code and it depends mainly on the dynamics of the physical processes and on the hardware sampling time). If the number of already acquired patterns is equal to or greater than NIP, the average is computed and as raw data the averaged ones are used; otherwise the program goes on with its calculation without computing any average and using the not averaged raw data of the current sample.

The function examines the second flag, the one that should allow phase b) to be executed, at the end of the first phase or if the first flag is 0. If the flag for the “filtering raw data” phase is 1, this operation is executed exploiting a low-pass filter whose cut-off frequency can be modified in the parameter setting phase.

The program goes on updating the data arrays used, according to the available chords. The final check is on the current maximum number of counts/s (useful for a reliable inversion): if it is less than the minimum allowed (also this number is set during the parameter setting phase), FUN_6 invokes a CEP, otherwise it ends without errors.

Following assumption g) and considering the adopted procedure for the determination of the SE local emissivity profile, it turns out that A_{ρ} is circularly symmetric with respect to the plasma geometric center. This, together with the fact that the geometric centre of the plasma does not necessarily coincides with the center of the vacuum vessel as already mentioned earlier, leads us to the need of adopting a coordinate system centered in the plasma geometric center. Purpose of FUN_7, shown in FIG. 19, is then to change the algorithm quantities that depend on the system coordinate, in order to make them consistent with the new coordinate system that will be considered from this point on and whose center is (R_{P}, 0, Z_{P}).

Actually, the only quantity useful for the following calculations and that needs to be recomputed regards the intercepts of the chords with the z axis. After this has been done, FUN_7 checks if the result of the previous computation falls in a numerical meaningful range. If this is the case, the function terminates without errors, otherwise a CEP is invoked.

FUN_8, whose flow chart can be seen in FIG. 20, is used to determine the intercepts A and B of the chords with the plasma boundary. Indeed, from the knowledge of these points it is then possible to compute the quantities rᵢ (see FIG. 9B), and consequently J_{ρi} and F (expressions (6) and (7)). The intercepts A and B are computed, for each chord, solving the following system of equations:
x²+z²=a² (19)
z=Tx+I. (20)
with T and I as previously defined.

Expression (19) holds for the plasma boundary and expression (20) holds for a line of sight. The 2^{nd} grade equation, function of x, which derives from the previous system is the following:
(1+T²)x²+2TIx+I²−a²=0. (21)

Its x solutions are given by:

$${x}_{1 , 2} = \frac{- TI ∓ \sqrt{Det}}{1 + {T}^{2}} , \qquad ( 22 )$$

where Det is the determinant
Det=(TI)²−(1+T²)(I²−a²) (23)

The z solutions can then be determined by expression (20).

FUN_8 repeats the following operations for each available chord: it computes the determinant by means of expression (23); if Det is greater than or equal to 0, this means that the line of sight is at least tangent to the plasma boundary, and so that there is at least a solution to expression (22); if there is at least a solution to expression (22), this is computed using expressions (22) and (20), otherwise the function checks the next chord. At the end of this cycle, FUN_8 verifies if the number of chords intercepting the plasma is greater than MNC: if this is not the case a CEP is issued, else the function ends with no errors.

FIG. 21 describes FUN_9, the function used to compute the matrix F. FUN_9 executes a loop, based on the number of available chords that remained after invoking FUN_8. At the beginning of each iteration the current portion of line of sight comprised in the plasma (whose extremes have been computed by FUN_8) is subdivided into NL points Pᵢ. After that, and following assumption g), the distance rᵢ of each of points Pi from the plasma geometric center O is computed. If the points are equally spaced, actually, for symmetry reason, only the distance of the first NL/2 points—(for example those belonging to segment AH in FIG. 9B) is computed. Having the rᵢ's it is then possible to determine J_{ρi} (see FIG. 11 and its caption). If this computation is with error, a CEP is invoked, the loop is aborted and the function terminated, else FUN_9 determines the integral F. If this computation is with errors, a CEP is invoked, the loop is aborted and the function terminates, else FUN_9 jumps to the following iteration.

FIG. 22 shows the steps of FUN_10, the function that computes the SE local emissivity profile A_{ρ}. This function is basically simple: at first it determines the matrix M (see expression (13)); then, if the former calculation returned with errors, a CEP is invoked and the function is ended, otherwise the profile A_{ρ} is computed by means of expression (13).

After the profile A_{ρ} is computed, it must be checked in order to see if it is a good one and it is reliable to use it for real-time purposes. Indeed, notwithstanding the preliminary phase of signal conditioning, the raw Y measurements could still present bad values coming from either hardware or software faults, that lead to a wrong calculation of A_{ρ}. FUN_11's duty is to check the profile A_{ρ}, and its flow chart is shown in FIG. 23. It is made of three segments and invokes a CEP if the examined feature is not satisfying. The checks are the following (it is worth mentioning that the last check was derived from empirical analyses):
1) Is the value of A_{ρ} on the boundary different from 0? [indeed, all the Bessel functions used in expression (9) are 0 on the plasma boundary—see also FIG. 10—therefore any combination of them must be 0 in that point];
2) Is there any value of A_{ρ}<0 or too big? [the SE local emissivity profile is a positive physical quantity which, therefore, cannot be less than 0];
3) Is the number of local maxima of A_{ρ} greater than the maximum allowed NLM? [NLM typically is equal to 4 and is a number that can be modified during the parameter setting phase];

Actually, the previous assessments of A_{ρ} are just the first step of a crosscheck process. The second step consists in evaluating the chi-square χ² between Y and the reconstructed line integrated measurements Y_{R} (see FIG. 25). Therefore, after the profile has been checked and it proved to be reliable, the reconstructed line integrated measurements Y_{R} have to be computed from A_{ρ}. This is the purpose of FUN_12, which is shown in FIG. 24. At first there is the determination of the matrix N (see expressions (2) and (11)); then the measurements Y_{R} are computed by means of expression (17). If Y_{R} presents any value less than 0, then the function issues a CEP and terminates, otherwise it ends without errors. The reason for invoking a CEP is simply due to the fact that Y_{R} reproduces a positive physical quantity and so it cannot be less than 0.

The flow chart of FUN_13 is shown in FIG. 25. This function computes the aforementioned χ² between Y and the reconstructed line integrated measurements Y_{R} (NC_{F} is the final number of chords used to determine A_{ρ}). After that, FUN_13 compares χ² with a threshold, whose value can be modified during the parameter setting phase. If χ² is greater than the threshold, the consequence is to discard the current A_{ρ} for the real-time purposes and to issue a CEP. It is worth noting that the χ² is computed after having normalized to 1 both Y and Y_{R}.

With the call of FUN_13 the main body of FUN_2 terminates (see FIG. 16) and basically at this point all the computations strictly related to the algorithm for the determination of A_{ρ} can be considered concluded.

After the main body of FUN_2 has been executed, the resulting and most relevant data must be written in the output buffer in order to store them in a database and/or use them for real-time purposes. This is achieved by FUN_3 (see FIG. 26), which is the only function of the writing body of FUN_2 (see also FIG. 16).

The first step is to normalize A_{ρ} between 0 and 1, since a normalized SE local emissivity profile is sufficient for the real-time control algorithm. Then the profile A_{ρ} is written in the output buffer both for recording in the database and for use in the real-time control. It is worth noting that if a CEP was issued before calling FUN_10, then the values of A_{ρ} written in the output buffer are those coming from FUN_4. The same procedures apply to the reconstructed line measurements Y_{R}. At last, other relevant parameters, like the abort_cycle flag, the chi-square χ² and the CEP event number, are sent to the output buffer. The abort_cycle flag is particularly important among them to check the profile validity: a value 0 for this flag means that the current SE local emissivity profile can be used for the feedback control, while a value 1 means that the current profile is not exploitable. In the latter case, the last valid SE local emissivity profile, obtained within a fixed time interval depending on physical issues (≈100 ms), is sent to the control system. If no valid profiles are available within this time interval, then an appropriated procedure for the pulse termination, out of the scope of this patent, is performed.

FIG. 27 represents an example of the SE local emissivity profile that was worked out, by the adopted inversion method, with the HXR data of one TS discharge (discharge no 32570) for a given time (t=10 s).

### CITED REFERENCES

[1] “Tomography of the fast electron bremsstrahlung emission during lower hybrid current drive on TORE SUPRA”, Y. Peysson and Frédéric Imbeaux, Rev. Sci. Instrum. 70 (10), 1999, pp. 3987-4007.
[2] “Tokamaks” J. Wesson, Clarendon Press (Oxford), 1997, pp. 108-121.

1. Process for determining a local emissivity profile of suprathermal electrons coming from an ionized gas ring, called plasma, placed in a toric vessel, with the use of a spectrometric system comprising at least one detector, the detector being positioned in relation with the toric vessel so that the line of sight of the detector intercepts a circular cross section of the toric vessel and a circular cross section of the ionized gas ring with radius “a”, said circular cross section of the ionized gas ring being off centre against said circular cross section of the toric vessel, characterized by the following steps:
to compute the first NB zeros Z₁, Z₂, . . . , Z_{NB} of the Bessel functions Jo of order 0,
to build a matrix J_{ρ}, the element of row k and column j of which is Jo(ρₖ*Zⱼ), with Jo(ρₖ*Zⱼ) being the function Jo of order 0 on arguments (ρₖ*Zⱼ) (k=1, 2, . . . , NM and j=1, 2, . . . , NB), with ρₖ the normalized distance with respect to radius “a” between a point Pₖ of the plasma and the plasma centre, the matrix J_{ρ} being such that:
A_{ρ}=J_{ρ}*C,
with A_{ρ} being an array, the elements of which represent the emissivity profile along a normalized plasma radius ρ and C being a matrix of coefficients,
to read measurement data, said measurement data comprising a plasma emissivity datum Y representing the plasma integrated emissivity measured by the detector along the line of sight, plasma centre coordinates comprising major radius value Rp, vertical shift value Zp and plasma minor radius “a”,
to compute the geometrical position of the line of sight segment which intercepts the cross section of the ionized gas ring with respect to a coordinate system centred in (Rp, 0, Zp),
to compute the position of NL successive points P₁, P₂, . . . , P_{NL} on said line of sight segment, P₁ and P_{NL} being the points of said line of sight segment which intercept boundaries of the ionized gas ring cross section,
to compute the distances rᵢ between the points Pᵢ (i=1, 2, . . . , NL) and the plasma centre and to computate the normalized distances ρᵢ=rᵢ/a,
to build a matrix J_{ρi}, the element of row i and column j of which is Jo(ρi*Zⱼ), with Jo(ρi*Zⱼ) being the function Jo of order 0 on arguments ρᵢ*Zⱼ (i=1, 2, . . . , NL and j=1, 2, . . . , NB), the matrix J_{ρi} being such that:
A_{ρi}=J_{ρi}*C,
with A_{ρi} being an array representing the emissivity profile along the normalized distances ρᵢ and C being said matrix of coefficients,
to compute for each column j of J_{ρi}, (j=1, 2, . . . , NB) integral Fⱼ such that:
Fⱼ=□*ΣᵢJo(ρᵢ*Zⱼ)
where □ is a geometric constant and i goes from 1 to NL,
to compute a matrix F such that:
F=[F₁F₂ . . . F_{NB}]
to compute a matrix F⁻¹, the pseudo-inverse matrix of matrix F,
to compute a matrix M such that:
M=(J_{ρ}*F⁻¹)/EG
with EG being the geometrical extension of the detector,
to calculate the suprathermal electron local emissivity profile array A_{ρ} such that:
A_{ρ}=M*Y/1000

2. Process according to claim 1, characterized in that it comprises a checking step to check the elements of the array A_{ρ}, said checking step comprising at least one of the following steps:
a) checking if the element of the array A_{ρ} which represents the local emissivity profile on the ionized gas ring circumference is different from zero,
b) checking if any element of the array A_{ρ} is negative or a value superior to a threshold value,
c) checking if the number of local maxima of the array A_{ρ} is greater than a maximum number allowed.

3. Process according to claim 1, characterized in that it comprises:
computation of (J_{ρ})⁻¹ the pseudo-inverse matrix of matrix J_{ρ},
computation of a matrix N such that:
N=(F*(J_{ρ})⁻¹)*EG,
computation of the reconstructed line integrated measurement Y_{R} corresponding to the integrated plasma emissivity datum Y such that:
Y_{R}=N*A_{ρ}*1000
computation of value χ² such that:
$${χ}^{2} = {\sum }_{n = 1}^{{NC}_{F}} {( {Y}_{n} - {Y}_{Rn} )}^{2} / {NC}_{F}$$
with Yₙ being the integrated plasma emissivity datum representing the integrated plasma emissivity measured by a detector of rank n, Y_{Rn} being the reconstructed line integrated measurement corresponding to the plasma emissivity datum Yₙ and NC_{F} being the number of detectors
checking if χ² is greater than a fixed threshold value.

4. Process according to claim 3, characterized in that, before the computation of value χ², it comprises a step for checking if at least one element of the array Y_{R} is negative.

5. Process according to claim 4, characterized in that, if at least one element of the array Y_{R} is negative, the process stops or it continues if not.

6. Process according to claim 3, characterized in that, if χ² is greater than a fixed threshold value, the process stops or it continues if not.

7. Process according to claim 1, characterized in that, if the points Pᵢ are equally spaced, the computation of the distances rᵢ between points Pᵢ (i=1, 2, . . . , NL) and the plasma centre is only made for the points Pᵢ located between P₁ and the middle of segment P₁P_{NL}, P₁ being included, or located between the middle of segment P₁P_{NL} and P_{NL}, P_{NL} being included.

8. Process according to claim 1, characterized in that it comprises an averaging phase to calculate said measurement emissivity datum Y in the form of raw integrated emissivity data computed along a prefixed number of consecutive time samples.

9. Process according to claim 1, characterized in that it comprises a step to filter raw measurement data.

10. Process according to claim 1, characterized in that it comprises a preliminary step to compare a number of available lines of sight to a minimum value allowed, so that the process stops if said number of available line of sights is lower than said minimum value allowed.

11. Process for real-time determination of the local emissivity profile of suprathermal electrons coming from a ionized gas ring, called plasma, placed in a toric vessel, said process comprising:
reading of at least one real-time measurement Y of integrated plasma emissivity along a line of sight of at least one detector positioned in relation with the toric vessel so that the line of sight of the detector intercepts a cross section of the toric vessel and a cross section of the ionized gas ring with radius “a”,
real-time reading of the plasma centre coordinates comprising major radius value Rp, vertical shift value Zp and plasma minor radius “a”,
real-time determination of the local emissivity profile based on a process according to claim 1.

12. Process according to claim 2, characterized in that it comprises:
computation of (J_{ρ})⁻¹ the pseudo-inverse matrix of matrix J_{ρ},
computation of a matrix N such that:
N=(F*(J_{ρ})⁻¹)*EG,
computation of the reconstructed line integrated measurement Y_{R} corresponding to the integrated plasma emissivity datum Y such that:
Y_{R}=N*A_{ρ}*1000
computation of value χ² such that:
$${χ}^{2} = {\sum }_{n = 1}^{{NC}_{F}} {( {Y}_{n} - {Y}_{Rn} )}^{2} / {NC}_{F}$$
with Yₙ being the integrated plasma emissivity datum representing the integrated plasma emissivity measured by a detector of rank n, Y_{Rn} being the reconstructed line integrated measurement corresponding to the plasma emissivity datum Yₙ and NC_{F} being the number of detectors
checking if χ² is greater than a fixed threshold value.
